(19) United States
(12) Patent Application Publication
(10) Pub. No.: US 2012/0244404 A1
(43) Pub. Date: Sep. 27, 2012

(54) PRISMATIC CELL SYSTEM WITH THERMAL MANAGEMENT FEATURES

(76) Inventors: Kem Obasih, Brookfield, WI (US); Richard M. DeKeuster, Racine, WI (US); Jason D. Fuhr, Sussex, WI (US); Xugang Zhang, Milwaukee, WI (US); Wataru Tsutsui, West Lafayette, IN (US)

(21) Appl. No.: 13/501,450

(22) PCT Filed: Oct. 13, 2010
(86) PCT No.: PCT/US10/52529

§ 371 Date: Jun. 14, 2012

Related U.S. Application Data
(60) Provisional application No. 61/251,656, filed on Oct. 14, 2009.

(51) Int. Cl. H01M 10/50; H01M 2/10

(52) U.S. Cl. 429/99; 429/120

(57) ABSTRACT

A battery module includes a plurality of electrochemical cells provided side-by-side one another and a thermal management feature extending substantially the length of the battery module. The thermal management feature is coupled to a first side of each of the electrochemical cells and includes a passage though which a thermal management fluid may pass and a heat sink provided within the passage to transfer heat between the electrochemical cells and the thermal management fluid.

### CROSS REFERENCE TO RELATED APPLICATIONS

This application claims the benefit of and priority to U.S. Provisional Patent Application No. 61/251,656, filed Oct. 14, 2009, and International Application No. PCT/US2010/052529, filed Oct. 13, 2010, the entire disclosures of which are incorporated herein by reference.

### BACKGROUND

The present application relates generally to the field of batteries and battery systems. More specifically, the present application relates to batteries and battery systems that may be used in vehicle applications to provide at least a portion of the motive power for the vehicle.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case of certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

A battery module includes a plurality of electrochemical cells provided side-by-side one another and a thermal management feature extending substantially the length of the battery module. The thermal management feature is coupled to a first side of each of the electrochemical cells and includes a passage though which a thermal management fluid may pass and a heat sink provided within the passage to transfer heat between the electrochemical cells and the thermal management fluid.

### DRAWINGS

FIG. 1 is a perspective view of a vehicle including a battery system according to an exemplary embodiment.

FIG. 2 is a cutaway schematic view of a vehicle including a battery system according to an exemplary embodiment.

FIG. 3 is a partial perspective view of a battery module for use in a battery system according to an exemplary embodiment.

FIGS. 4A-4D are partial cross-sectional views of the battery module of FIG. 3 taken along line 4-4 of FIG. 3 according to various exemplary embodiments.

FIGS. 5A-5C are side views of a battery module according to various exemplary embodiments.

FIG. 6 is a partial perspective view of a battery module for use in a battery system according to another exemplary embodiment.

FIG. 7 is a cross-sectional view of the battery module of FIG. 6 taken along line 7-7 of FIG. 6 according to an exemplary embodiment.

FIG. 8 is a partial perspective view of a battery module for use in a battery system according to another exemplary embodiment.

FIG. 9 is a cross-sectional view of the battery module of FIG. 8 taken along line 9-9 of FIG. 8 according to an exemplary embodiment.

FIG. 10 is a partial perspective view of a battery module for use in a battery system according to another exemplary embodiment.

FIG. 11 is a cross-sectional view of the battery module of FIG. 10 taken along line 11-11 of FIG. 10 according to an exemplary embodiment.

FIG. 12 is a partial perspective view of a battery module for use in a battery system according to another exemplary embodiment.

FIG. 13 is a cross-sectional view of the battery module of FIG. 12 taken along line 13-13 of FIG. 12 according to an exemplary embodiment.

FIG. 14 is a partial perspective view of a battery module for use in a battery system according to another exemplary embodiment.

FIG. 15 is a partial perspective view of a battery module for use in a battery system according to another exemplary embodiment.

FIG. 16 is a partial perspective view of a battery module for use in a battery system according to another exemplary embodiment.

FIG. 17 is a partial perspective view of a battery system including a plurality of battery modules as shown in FIG. 3 according to an exemplary embodiment.

FIG. 18 is a top view of the battery system of FIG. 17 according to an exemplary embodiment.

FIG. 19 is a perspective view of an electrochemical cell according to an exemplary embodiment.

FIG. 20 is a cross-sectional view of a portion of the electrochemical cell of FIG. 19 taken along line 20-20 of FIG. 19 according to an exemplary embodiment.

FIG. 21 is a partial exploded view of a portion of the electrochemical cell of FIG. 19 according to an exemplary embodiment.

### DETAILED DESCRIPTION

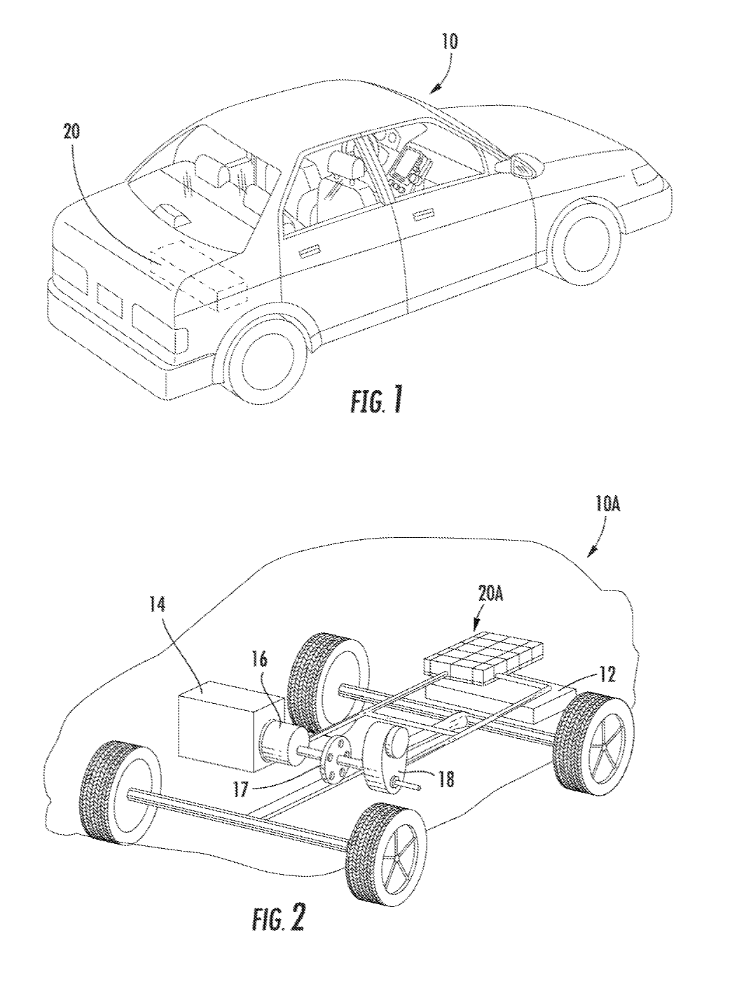

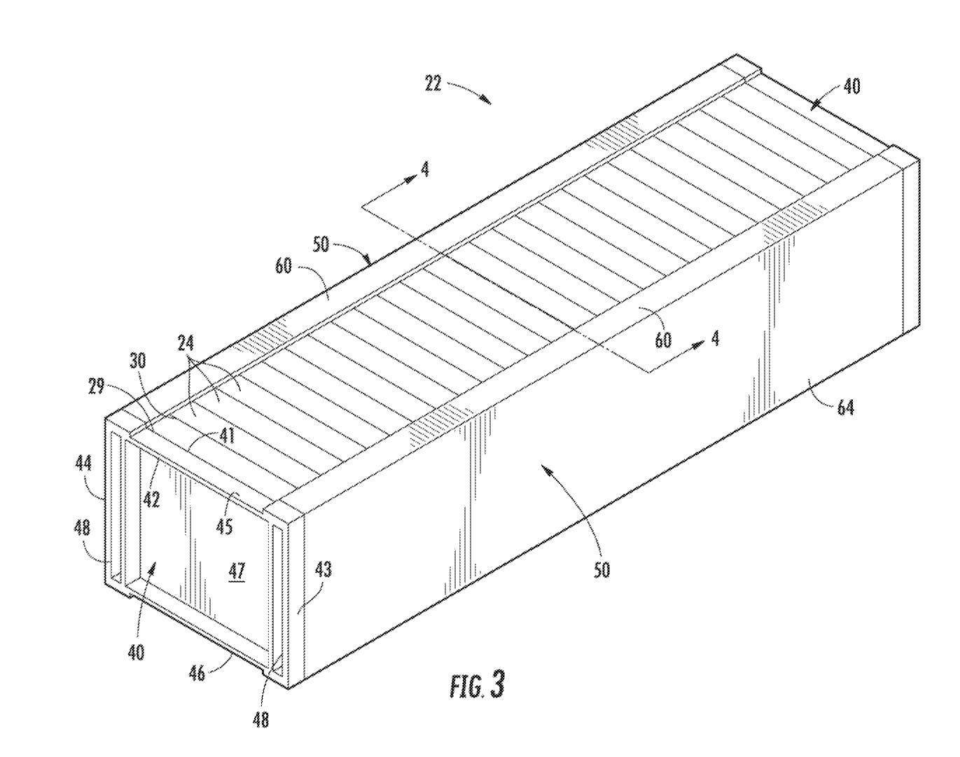

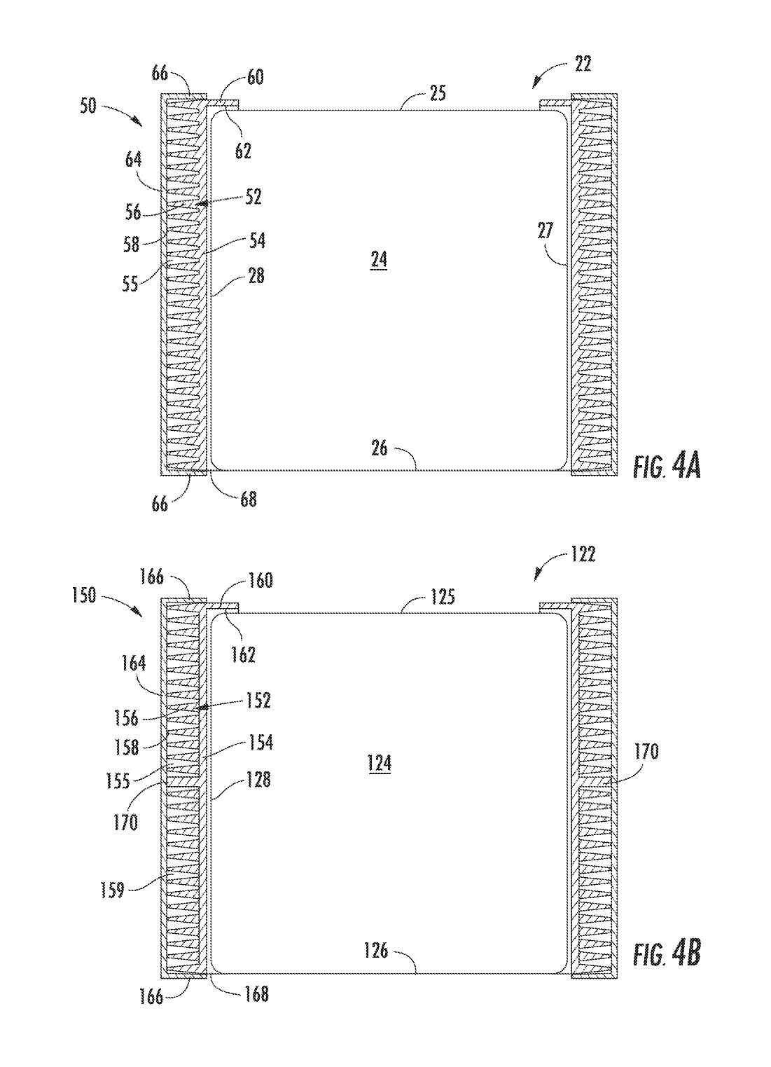

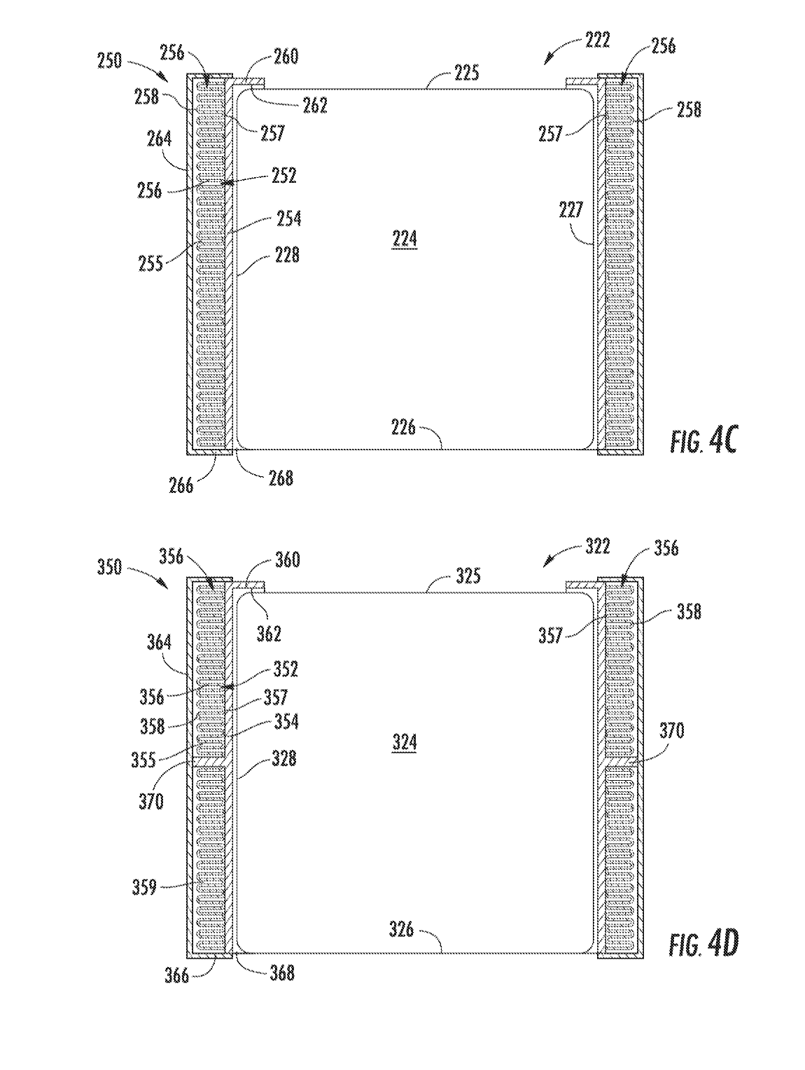

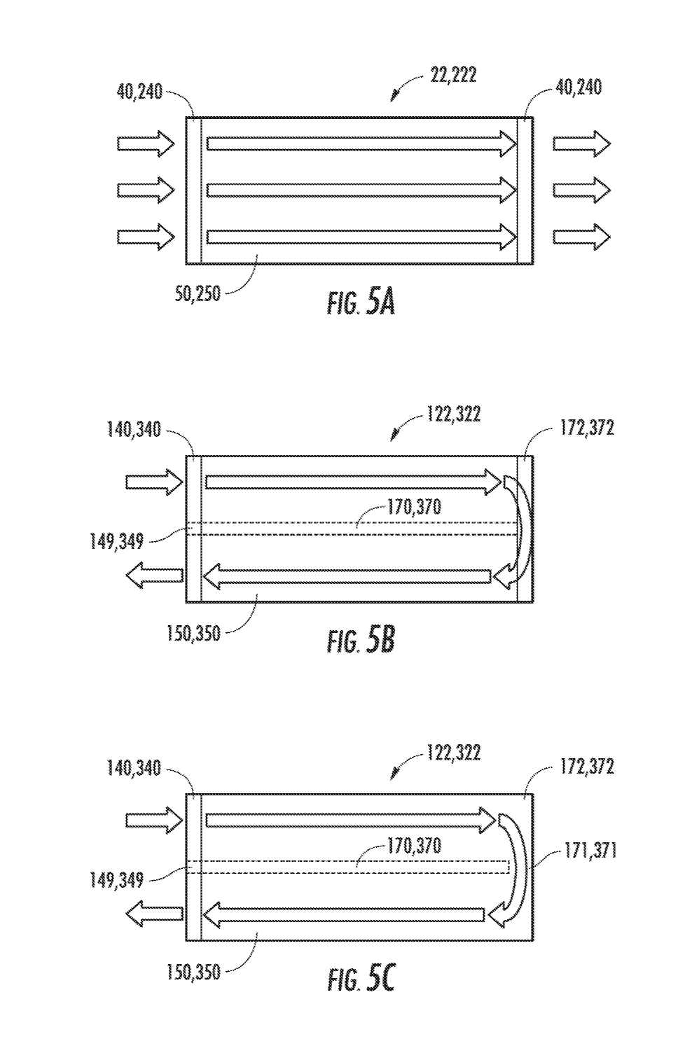

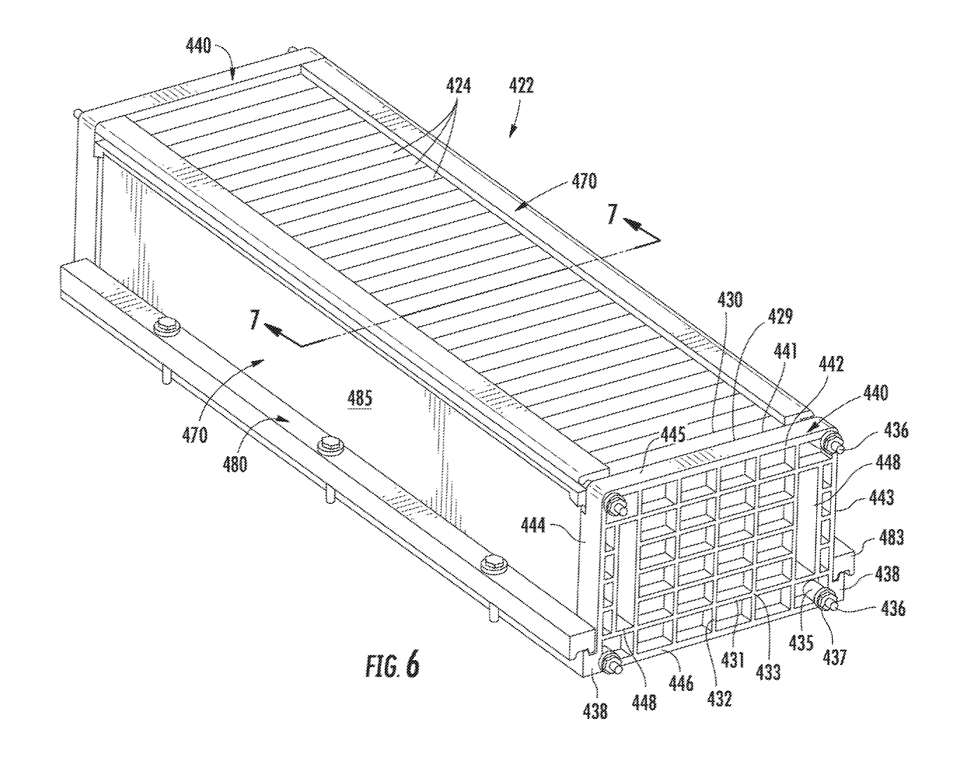

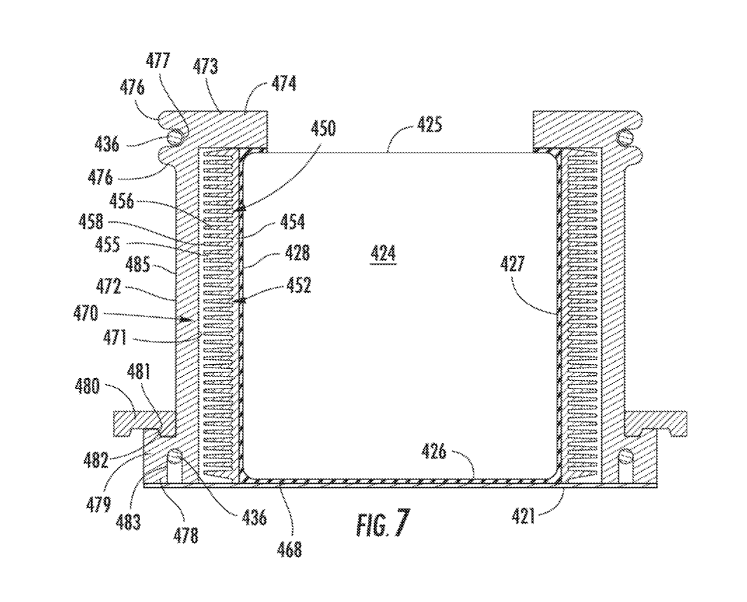

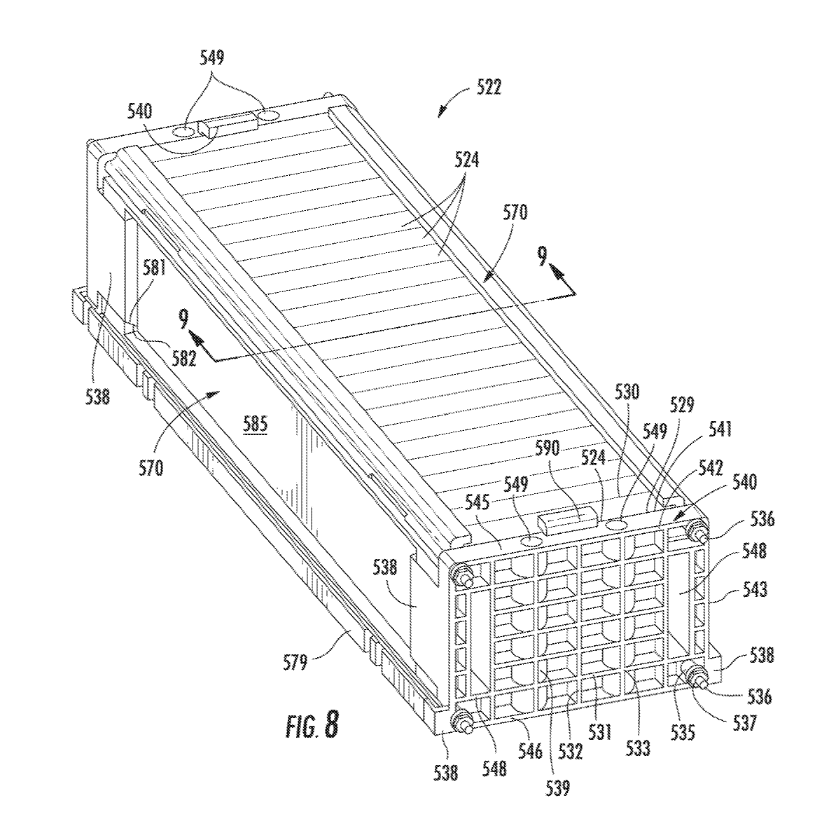

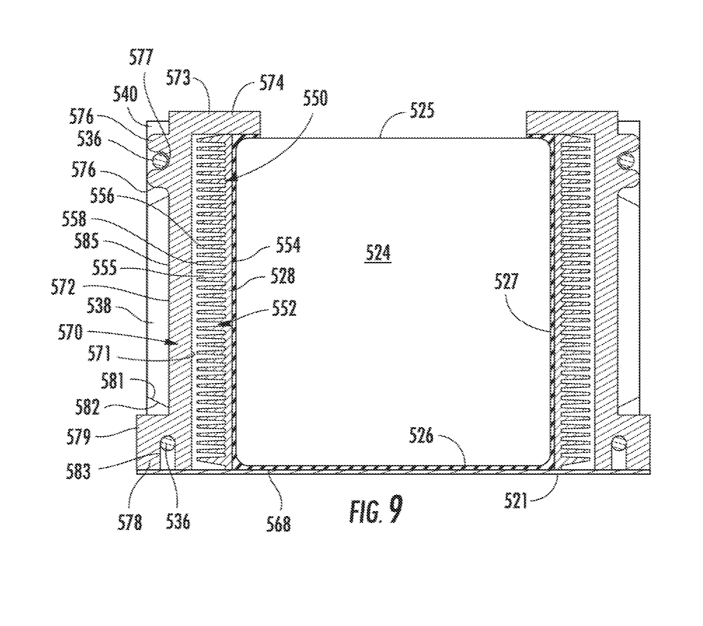

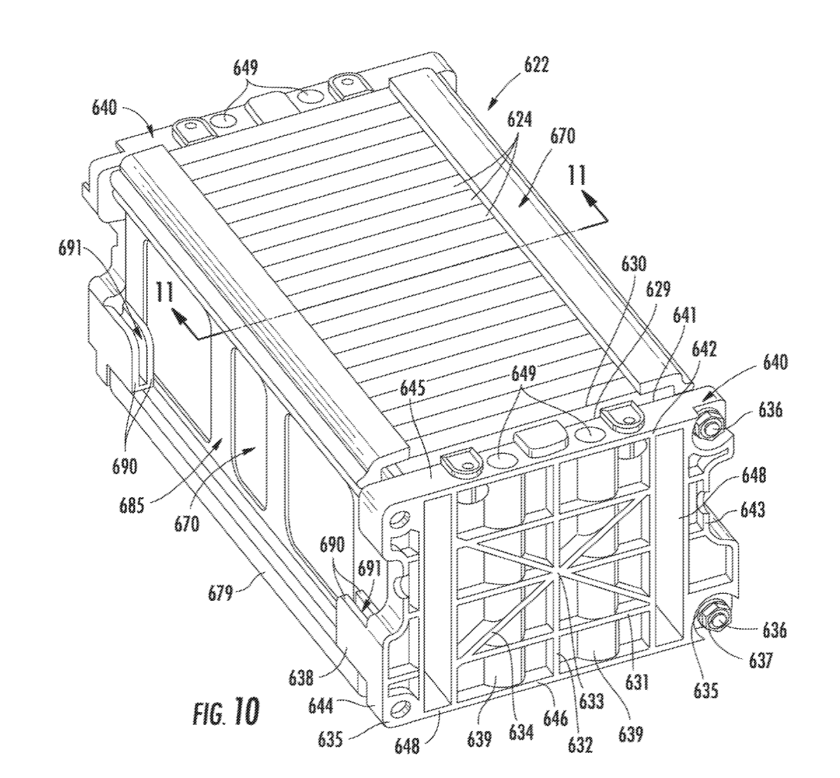

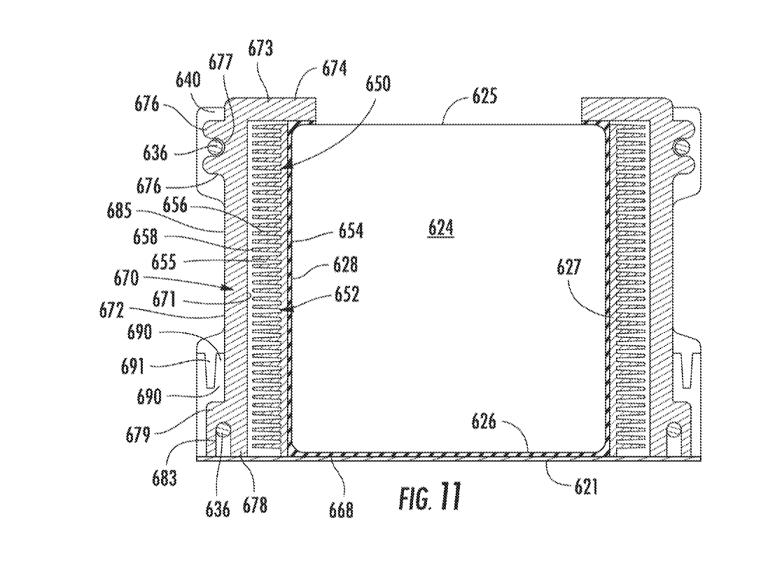

FIG. 1 is a perspective view of a vehicle 10 in the form of an automobile (e.g., a car) having a battery system 20 for providing all or a portion of the motive power for the vehicle 10. Such a vehicle 10 can be an electric vehicle (EV), a hybrid electric vehicle (HEV), a plug-in hybrid electric vehicle (PHEV), or other type of vehicle using electric power for propulsion (collectively referred to as “electric vehicles”).

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents, or cooling devices, etc.), and a variety of other considerations.

FIG. 2 illustrates a cutaway schematic view of a vehicle 10A provided in the form of an HEV according to an exemplary embodiment. A battery system 20A is provided toward the rear of the vehicle 10A proximate a fuel tank 12 (the battery system 20A may be provided immediately adjacent the fuel tank 12 or may be provided in a separate compartment in the rear of the vehicle 10A (e.g., a trunk) or may be provided elsewhere in the vehicle 10A). An internal combustion engine 14 is provided for times when the vehicle 10A utilizes gasoline power to propel the vehicle 10A. An electric motor 16, a power split device 17, and a generator 18 are also provided as part of the vehicle drive system.

Such a vehicle 10A may be powered or driven by just the battery system 20A, by just the engine 14, or by both the battery system 20A and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery systems 20, 20A, the type of vehicles 10, 10A, the type of vehicle technology (e.g., EV, HEV, PHEV, etc.), and the battery chemistry, among other features, may differ from those shown or described.

According to an exemplary embodiment, the battery system includes electrochemical cells or batteries (such as cells 24 shown in FIG. 3), and includes features or components for connecting the electrochemical cells to each other and/or to other components of the vehicle electrical system, and also for regulating the electrochemical cells and other features of the battery system. For example, the battery system may include features that are responsible for monitoring and controlling the electrical performance of the system, managing the thermal behavior of the system, containment and/or routing of effluent (e.g., gases that may be vented from a battery cell), and other aspects of the battery system.

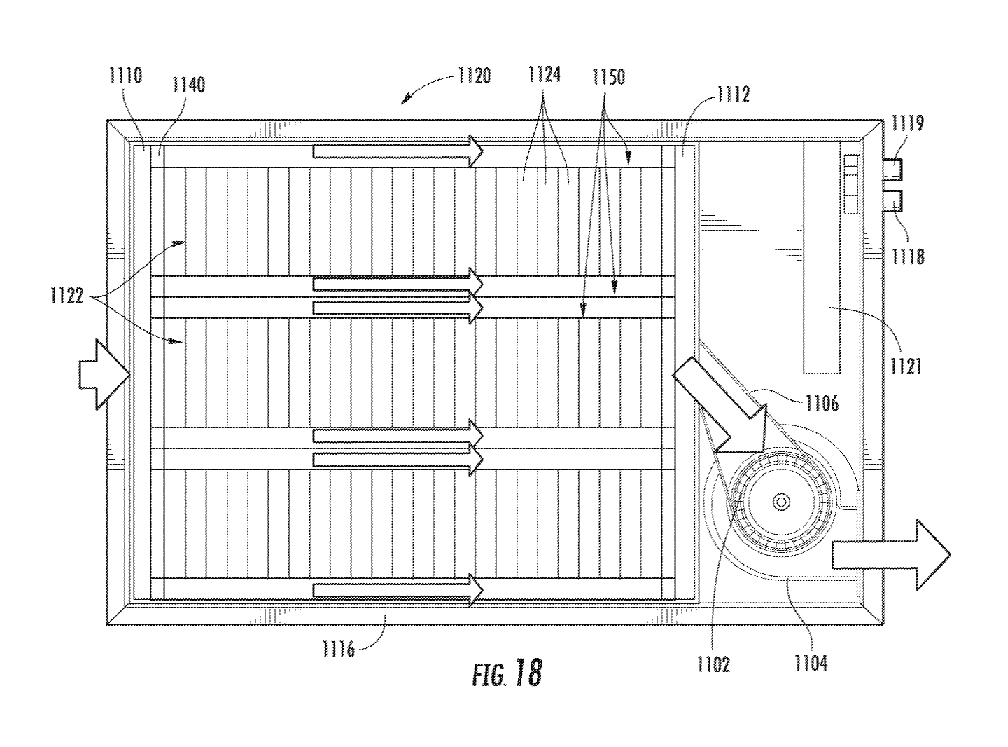

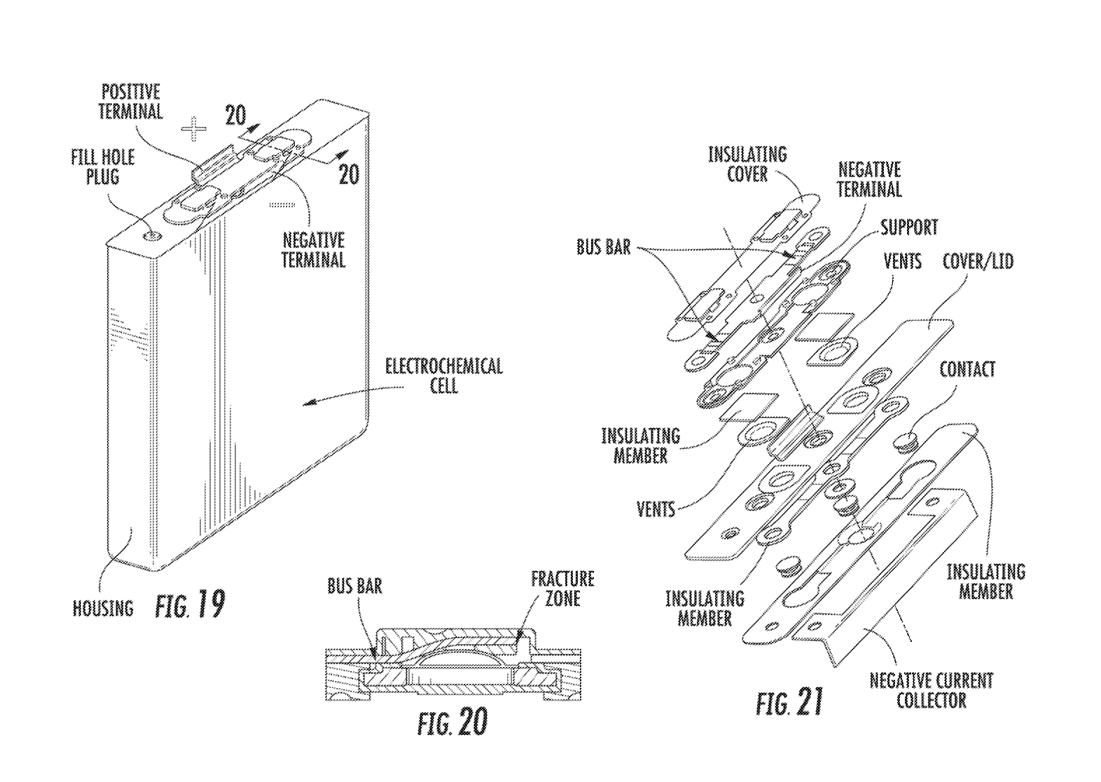

Referring now to FIGS. 3-4A, a battery module 22 is shown according to an exemplary embodiment. The battery module 22 includes a plurality of electrochemical cells 24. According to an exemplary embodiment, the electrochemical cells 24 may be, for example, lithium-ion cells, nickel-metal-hydride cells, lithium polymer cells, etc., or other types of electrochemical cells now known or hereafter developed. According to an exemplary embodiment, the cells 24 include at least one terminal (e.g., such as the positive and negative terminals shown in FIG. 19). It should be noted that the embodiments shown in FIGS. 4B-21 may also use these types of cells.

According to an exemplary embodiment, the electrochemical cells 24 are generally prismatic lithium-ion cells configured to store an electrical charge. According to other exemplary embodiments, the electrochemical cells 24 could have other physical configurations (e.g., oval, cylindrical, polygonal, etc.). The capacity, size, design, and other features of the electrochemical cells 24 may also differ from those shown according to other exemplary embodiments.

According to an exemplary embodiment, each of the electrochemical cells 24 includes a top 25, a bottom 26 that is opposite the top 25, a first side 27, and a second side 28 opposite the first side 27. The electrochemical cell 24 also includes sides or faces 29, that interconnect the top 25, bottom 26, first side 27, and second side 28. As shown in FIG. 3, the electrochemical cells 24 are provided side-by-side one another such that a face 29 of a first electrochemical cell 24 is adjacent a face 30 of a second electrochemical cell 24 (e.g., the cells face one another). As such, each of the first sides 27 of the electrochemical cells 24 are provided on a first side of the battery module 22 while all of the second sides 28 of each of the electrochemical cells 24 are provided on a second side of the battery module 22 opposite that of the first side of the battery module 22. According to one exemplary embodiment, an electrically insulative member (not shown) may be provided in between adjacent cells (i.e., between the faces 29, 30).

According to one exemplary embodiment, a space or gap may be provided between adjacent cells 24. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (e.g., the spacers or other members would allow for rigid connections between the cells).

As shown in FIG. 3, the battery module 22 also includes a structure or member shown as an end cap 40 provided at a first end of the battery module 22. According to an exemplary embodiment, the end cap 40 includes a first face 41 and a second face 42 generally opposite the first face 41. As shown in FIG. 3, the first face 41 is provided adjacent a face 29 of the electrochemical cells 24. The end cap 40 also includes a first end 43 and a second end 44 generally opposite of the first end 43. A pair of apertures or openings 48 are provided adjacent each of the ends 43, 44. According to an exemplary embodiment, the openings 48 generally extend from a top 45 of the end cap to a bottom 46 of the end cap 40. As shown in FIG. 3, the openings 48 have a generally rectangular shape; however, the openings may have a different size, shape, or configuration according to other exemplary embodiments.

According to an exemplary embodiment, the end cap 40 also includes a compartment or recess 47 defined by the first and second ends 43, 44 and the top and bottom 45, 46 of the end cap 40. According to an exemplary embodiment, the recess 47 is configured to receive electronics or a control circuit(s) that are configured to monitor and/or regulate at least a portion of the electrochemical cells 24 provided in the module 22. For example, the recess 47 may be configured to receive a cell supervisory controller (CSC), which may include a printed circuit board having temperature, voltage, and/or current sensors, or other electronic components mounted thereon.

According to an exemplary embodiment, the CSC may be mounted on a member or trace board (e.g., a printed circuit board). The trace board includes the necessary wiring to connect the CSC to the individual cells and to connect the CSC to the battery management system (BMS) of the battery system. The trace board includes various connectors to make these connections possible (e.g., temperature connectors, electrical connectors, voltage connectors, etc.).

According to an exemplary embodiment, the battery module 22 includes at least one cell supervisory controller (CSC) to monitor and regulate the electrochemical cells as needed. According to one exemplary embodiment, a CSC may be located at each end of the battery module 22 (e.g., within the recess 47).

According to an exemplary embodiment, battery module 22 includes a thermal management feature 50. According to an exemplary embodiment, the thermal management feature 50 is configured to route a thermal management fluid (e.g., air, liquid, etc.) through a passage (e.g., channel, path, route, conduit, etc.) within the thermal management feature 50. The passage may include a heat sink (such as, e.g., heat sinks 52, 152, 252, 352 shown in FIGS. 4A-4B) to transfer heat between the cells 24 and the thermal management fluid. According to one exemplary embodiment, the thermal management feature 50 includes a box-like structure or housing that is configured to define the passage for the thermal management fluid to pass therethrough.

As shown in FIG. 3, the thermal management feature 50 is provided on the first side of the battery module 22 and extends from the first end of battery module 22 adjacent the first sides 27 of the electrochemical cells 24 to the second end of the battery module 22. According to the exemplary embodiment shown in FIG. 3, a second thermal management feature 50 is provided on the second side of the battery module 22 and extends from the first end of battery module 22 adjacent the second sides 27 of the electrochemical cells 24 to the second end of the battery module 22.

According to an exemplary embodiment, the openings 48 of the end cap 40 are in fluid communication with the thermal management features 50. These openings 48 are configured to allow a thermal management fluid (e.g., air, liquid, etc.) to pass therethrough and enter the thermal management feature 50 to cool or heat the electrochemical cells 24.

As shown in FIG. 3, the thermal management features 50 extend substantially the entire length of the battery module 22 as well as extending across substantially the entire height of the cells 24. However, according to other exemplary embodiments, the thermal management feature may have a different size and/or shape. For example, the thermal management feature 50 may extend only a portion of the length or height of the battery module. Various thermal management features will now be described below in regard to FIGS. 4A-4D. It should be noted, however, that one of ordinary skill in the art would readily recognize that other thermal management features are usable with the battery module 22.

Referring now to FIG. 4A, a thermal management feature 50 is shown according to one exemplary embodiment. The thermal management feature 50 includes a heat sink 52 having a base 54 that is coupled to the side of the electrochemical cell 24. The heat sink 52 further includes a plurality of fins 56 that extend out from the base 54. Passages 55 are provided between adjacent fins 56. As shown in FIG. 4A, according to an exemplary embodiment, the fins 56 are tapered (e.g., become smaller) from the base 54 to a tip 58 of the fins 56. However, according to other exemplary embodiments, the fins may not be tapered or may have another configuration. According to one exemplary embodiment, the tips 58 of the fins 56 are in contact with the cover 64. However, according to other exemplary embodiments, the tips 58 may not contact the cover 64.

According to an exemplary embodiment, the passages 55 are configured to receive a thermal management fluid therethrough to cool or heat the heat sink 52 (and thus the cells 24). According to an exemplary embodiment, the thermal management fluid is a gas such as air, or a liquid such as a coolant (e.g., water, water/glycol mixture, refrigerant, etc.)

According to an exemplary embodiment, a cover 64 may be provided over the heat sink 52 to substantially enclose the face of the heat sink 52. As shown in FIG. 4A, the cover 64 includes flanges 66 that are used to couple the cover to the heat sink 52. However, according to other exemplary embodiments, the cover 64 may be otherwise coupled to the heat sink 52. According to one exemplary embodiment, the tips 58 of the fins 56 are in contact with the cover 64. However, according to other exemplary embodiments, the tips 58 may not contact the cover 64.

According to an exemplary embodiment, the heat sink 52 also includes a member 60 (e.g., extension, projection, flange, etc.) that extends out from the base 54 generally opposite the fins 56 at a top of the base 54. The member 60 is configured to extend over a portion of the top 25 of the cell 24 to exert a clamping force on the cells 24 (e.g., when the thermal management feature is coupled to a housing of the battery module or battery system). According to an exemplary embodiment, the member 60 includes a face 62 that exerts or applies a clamping force to the cell 24.

As shown in FIG. 4A, the member 60 exerts a clamping force in a first or vertical direction; however, according to other exemplary embodiments, the orientation of the cells 24 and of the battery module 22 may be different, and thus the relative orientation of the clamping force may also be different.

According to one exemplary embodiment, an electrically insulative member shown as insulator 68 may be provided between the heat sink 52 and the electrochemical cells 24. However, according to another exemplary embodiment, the insulator is not included within the battery module (i.e., the heat sink 52 is provided directly adjacent to the electrochemical cells 24). According to an exemplary embodiment, the insulator 68 provides electrical insulation between the cell 24 and the heat sink 52 but allows thermal transfer to readily occur between the cell 24 and the heat sink 52.

According to an exemplary embodiment, the insulator 68 comprises an electrically insulating, yet thermally conductive material (e.g., silicone, polyvinyl chloride (PVC), or other suitable material). According to an exemplary embodiment, the insulator 68 has a thickness in the range of approximately 0.05 to 0.25 millimeters. According to another exemplary embodiment, the insulator 68 has a thickness of 0.13 millimeters. However, the thickness of the insulator 68 may be greater or smaller according to other exemplary embodiments.

Referring now to FIG. 4B, a thermal management feature 150 is shown according to an exemplary embodiment. According to an exemplary embodiment, the thermal management feature 150 includes features similar to those in FIG. 4A (with similar features to those in FIG. 4A labeled with corresponding reference numbers in the 100 series).

As shown in FIG. 4B, the thermal management feature 150 includes a member shown as a divider 170 provided generally in the center of the heat sink 152. However, according to other exemplary embodiments, the divider 170 may be provided elsewhere. The divider 170 extends from the base 154 to the cover 164 to separate the heat sink 152 into a first set of passages 155 and a second set of passages 159.

According to an exemplary embodiment, a connection member (such as, e.g., connection member 172 shown in FIG. 5B) may be provided at an end of the heat sink 152 to route or direct fluid from the first set of passages 155 to the second set of passages 159 (e.g., as shown in FIG. 5B). According to another exemplary embodiment, the divider 170 may be provided within the heat sink 152 such that a gap 171 exists between an end of the divider 170 and the end of the heat sink 152 to allow fluid from the first set of passages 155 to enter the second set of passages 159 (e.g., as shown in FIG. 5C).

One advantage of having the fluid flow in a first direction through the first set of passages 155 and then in a second direction through the second set of passages 159 is that it allows for more even cooling (or heating) of the cells 124 in the battery module. This helps to result in the cells 124 having a longer life and more even operating characteristics (e.g., voltage, current, charge capacity, etc.).

Referring now to FIG. 4C, a thermal management feature 250 is shown according to an exemplary embodiment. According to an exemplary embodiment, the thermal management feature 250 includes features similar to those in FIG. 4A (with similar features to those in FIG. 4A labeled with corresponding reference numbers in the 200 series).

As shown in FIG. 4C, the thermal management feature 250 includes a heat sink 252. According to an exemplary embodiment, the heat sink 252 includes a folded sheet 256 that is folded multiple times to produce a first side 257 and a second side 258. According to an exemplary embodiment, the first side 257 is coupled (e.g., welded, braised, etc.) to the base 254 of the heat sink 252, creating passages 255 between the individual folds of the folded sheet 256. The passages 255 are configured for receiving a thermal management fluid therethrough to cool or heat the electrochemical cells 224.

According to an exemplary embodiment, the folded sheet 256 may be made of any suitable material, such as, for example aluminum (or aluminum alloy), steel (or steel alloy), copper (or copper alloy), etc. According to an exemplary embodiment, the folded sheet 256 is manufactured from a single flat sheet (e.g., a flat piece of sheet metal) which is then folded multiple times in an accordion-like manner. According to other exemplary embodiments, however, the folded sheet 256 may be constructed from multiple pieces that are then coupled together.

Referring now to FIG. 4D, a thermal management feature 350 is shown according to an exemplary embodiment. According to an exemplary embodiment, the thermal management feature 350 includes features similar to those in FIG. 4A (with similar features to those in FIG. 4A labeled with corresponding reference numbers in the 300 series).

As shown in FIG. 4D, the thermal management feature 350 includes a member shown as a divider 370 provided generally in the center of the heat sink 352. However, according to other exemplary embodiments, the divider 370 may be provided elsewhere. The divider 370 extends from the base 354 to the cover 364 to separate the heat sink 352 into a first set of passages 355 and a second set of passages 359.

According to an exemplary embodiment, a connection member (such as, e.g., connection member 372 shown in FIG. 5B) may be provided at an end of the heat sink 352 to route or direct fluid from the first set of passages 355 to the second set of passages 359 (e.g., as shown in FIG. 5B). According to another exemplary embodiment, the divider 370 may be provided within the heat sink 352 such that a gap 371 exists between an end of the divider 370 and the end of the heat sink 352 to allow fluid from the first set of passages 355 to enter the second set of passages 359 (e.g., as shown in FIG. 5C).

Referring now to FIGS. 5A-5C, side views of a battery module (such as, e.g., as shown in FIGS. 3-4D) are shown according to various exemplary embodiments. FIG. 5A shows the flow of the thermal management fluid through the battery module 22, 222 according to an exemplary embodiment. The thermal management fluid enters a first end of the battery module 22, 222 near the end cap 40, 240, travels through the thermal management feature 50, 250 and exits out the second end of the battery module 22, 222 near the end cap 40, 240.

According to another exemplary embodiment, FIG. 5B shows the flow of the thermal management fluid through the battery module 122, 322 according to an exemplary embodiment. The thermal management fluid enters the thermal management feature 150, 350 at a first end of the battery module 122, 322 near the end cap 140, 340, travels to the second end of the battery module 122, 322 and then travels back to the first end of the battery module 122, 322. As shown in FIG. 5B, a device shown as a connection member 172, 372 is configured to route thermal management fluid from the first set of passages 155, 355 to the second set of passages 159, 359.

According to another exemplary embodiment, as shown in FIG. 5C, a gap 171, 371 provided between the divider 170, 370 and the end of the battery module 122, 322 is configured to allow the thermal management fluid to transition from the first set of passages 155, 355 to the second set of passages 159, 359.

According to an exemplary embodiment, the end cap 140, 340 provided at the first end of the battery module 122, 322 may include a member or feature 149, 349 that is aligned with the divider 170, 370 of the thermal management feature 150, 350. The member 149, 349 is configured to aid in the sealing and separation of the flow of the thermal management fluid through the end cap 140, 340 and into or out of the thermal management feature 150, 350 of the battery module 122, 322.

Referring now to FIGS. 6-7, a battery module 422 is shown according to another exemplary embodiment. According to an exemplary embodiment, the battery module 422 includes features similar to those in FIGS. 3-4A (with similar features to those in FIGS. 3-4A labeled with corresponding reference numbers in the 400 series).

As shown in FIGS. 6-7, the battery module 422 includes a plurality of electrochemical cells 424. According to an exemplary embodiment, each of the electrochemical cells 424 includes a top 425, a bottom 426 that is opposite the top 425, a first side 427, and a second side 428 opposite the first side 427. The electrochemical cell 424 also includes sides or faces 429, 430 that interconnect the top 425, bottom 426, first side 427, and second side 428. According to an exemplary embodiment, the cells 424 include at least one terminal (e.g., such as the positive and negative terminals shown in FIG. 19).

As shown in FIG. 6, the electrochemical cells 424 are provided side-by-side one another such that a face 429 of a first electrochemical cell 424 is adjacent a face 430 of a second electrochemical cell 424 (e.g., the cells face one another). As such, each of the first sides 427 of the electrochemical cells 424 are provided on a first side of the battery module 422 while all of the second sides 428 of each of the electrochemical cells 424 are provided on a second side of the battery module 422 opposite that of the first side of the battery module 422. According to one exemplary embodiment, an electrically insulative member (not shown) may be provided in between adjacent cells (i.e., between the faces 429, 430).

According to one exemplary embodiment, a space or gap may be provided between adjacent cells 424. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (e.g., the spacers or other members would allow for rigid connections between the cells).

According to an exemplary embodiment, the battery module 422 includes a member or structure shown as an end cap 440 provided at a first end of the battery module 422. According to an exemplary embodiment, the end cap 440 includes a first face 441 and a second face 442 generally opposite the first face 441. As shown in FIG. 6, the first face 441 is provided adjacent a face 429 of one of the electrochemical cells 424. The end cap 440 also includes a first end 443 and a second end 444 generally opposite of the first end 443 and a top 445 and a bottom 446 generally opposite the top 445.

According to an exemplary embodiment, the first and second ends 443, 444 and the top and bottom 445, 446 are each connected with a plurality of generally horizontal members 431 (beams, ribs, supports, braces, etc.) and a plurality of generally vertical members 432 (beams, ribs, supports, braces, etc.). As shown in FIG. 6, the horizontal and vertical members 431, 432 are coupled with one another at intersection points 433. According to one exemplary embodiment, the first face 441 of the end cap 440 is a generally solid surface (i.e., flat continuous surface). However, according to another exemplary embodiment, the first face 441 may contain openings or windows between the horizontal and vertical members 431, 432.

According to an exemplary embodiment, the horizontal and vertical members 431, 432 of the end cap 440 also form a pair of apertures or openings 448. As shown in FIG. 6, according to an exemplary embodiment, the openings 448 are generally provided near the ends 443, 444 and extend from near the top 445 of the end cap 440 to near the bottom 446 of the end cap 440. As shown in FIG. 6, the openings 448 have a generally rectangular shape; however, the openings may have a different size, shape, or configuration according to other exemplary embodiments.

According to an exemplary embodiment, the openings 448 of the end cap 440 are in fluid communication with thermal management features 450 of the battery module 422. These openings 448 are configured to allow a thermal management fluid (e.g., air, liquid, etc.) to pass therethrough and enter the thermal management feature 450 to cool or heat the electrochemical cells 424.

According to an exemplary embodiment, the end cap 440 includes features or bosses 435 that are configured to receive a fastener or tie rod 436 therethrough. As shown in FIG. 6, each of the bosses 435 are located substantially in a corner of the end cap 440. According to an exemplary embodiment, nuts 437 are used to tighten the tie rods 436 within the battery module 422.

As shown in FIG. 6, according to an exemplary embodiment, a second end cap 440 is provided at a second end of the battery module 422 opposite that of the first end cap 440. According to the exemplary embodiment shown in FIG. 6, the tie rod 436 extends through the bosses 435 of each of the end caps 440 and is tightened using the nuts 437 to exert a clamping force on the plurality of electrochemical cells 424 in a generally horizontal direction.

According to an exemplary embodiment, the battery module 422 includes a pair of members or structures shown as side clamps 470. The side clamps 470 include a first surface 471 and a second surface 472 generally opposite of the first surface 471. According to an exemplary embodiment, the first surface 471 faces the thermal management feature 450 of the battery module 422 and helps to position and/or retain the thermal management feature 450 adjacent the cells 424 within the battery module 422.

According to an exemplary embodiment, each of the thermal management features 450 is configured to route a thermal management fluid (e.g., air, liquid, etc.) through a passage (e.g., channel, path, route, conduit, etc.) within the thermal management feature 450. The passage may include a heat sink (such as, e.g., heat sinks 52, 152, 252, 352 shown in FIGS. 4A-4B) to transfer heat between the cells 424 and the thermal management fluid. According to one exemplary embodiment, the thermal management feature 450 includes a box-like structure or housing that is configured to define the passage for the thermal management fluid to pass therethrough.

As shown in FIG. 7, according to an exemplary embodiment, each of the thermal management features 450 includes a heat sink 452 having a base 454 that is coupled to the side of the electrochemical cell 424. The heat sink 452 further includes a plurality of fins 456 that extend out from the base 454. Passages 455 are provided between adjacent fins 456. As shown in FIG. 7, according to an exemplary embodiment, the fins 456 are tapered (e.g., become smaller) from the base 454 to a tip 458 of the fins 456. However, according to other exemplary embodiments, the fins may not be tapered or may have another configuration. According to other exemplary embodiments, the thermal management features 450 may be configured similar to the thermal management features discussed above in regard to FIGS. 4B-4D.

According to an exemplary embodiment, the passages 455 are configured to receive a thermal management fluid therethrough to cool or heat the heat sink 452 (and thus the cells 424). According to an exemplary embodiment, the thermal management fluid is a gas such as air, or a liquid such as a coolant (e.g., water, water/glycol mixture, refrigerant, etc.). According to one exemplary embodiment, the tips 458 of the fins 456 are in contact with the first surface 471 of the side clamps 470. However, according to other exemplary embodiments, the tips 458 may not contact the side clamps 470.

According to one exemplary embodiment, an electrically insulative member shown as insulator 468 may be provided between the heat sink 452 and the electrochemical cells 424. However, according to another exemplary embodiment, the insulator is not included within the battery module (i.e., the heat sink 452 is provided directly adjacent to the electrochemical cells 424).

According to an exemplary embodiment, the insulator 468 provides electrical insulation between the cell 444 and the heat sink 452 but allows thermal transfer to readily occur between the cell 424 and the heat sink 452. As shown in FIG. 7, the insulator 468 extends along the bottom 426 of the cell 424 between the cell 424 and a bottom 421 of the battery system housing.

According to an exemplary embodiment, the insulator 468 comprises an electrically insulating, yet thermally conductive material (e.g., silicone, polyvinyl chloride (PVC), or other suitable material). According to an exemplary embodiment, the insulator 468 has a thickness in the range of approximately 0.05 to 0.25 millimeters. According to another exemplary embodiment, the insulator 468 has a thickness of 0.13 millimeters. However, the thickness of the insulator 468 may be greater or smaller according to other exemplary embodiments.

According to one exemplary embodiment, a top portion 473 of the first surface 471 of the side clamp 470 includes a feature or member 474 for clamping the electrochemical cells 424 in a generally vertical direction. The member 474 extends out and away from the first surface 471 and extends over at least a portion of the top of the cells 424.

According to the exemplary embodiment shown in FIGS. 6-7, the top portion 475 of the second surface 472 includes a pair of projections 476 that form a groove 477 to hold or retain the tie rod 436. The second surface 472 also includes a bottom portion 478 having a slot 483 configured to receive a tie rod 436. The bottom portion 478 also has a flange 479 extending out from the second surface 472. The flange 479 is configured to receive a portion of a member shown as a clamping bar 480. The clamping bar 480 is configured to be bolted or otherwise secured to a housing of the battery system to which the battery module 422 is provided in. The clamping bar 480 has features 481 that are configured to interact with corresponding features 482 of the flange 479 to aid in aligning the clamping bar 480 to the flange 479.

When the clamping bar 480 is secured to the battery system (e.g., a bottom 421 of the battery system housing), the clamping bar 480 exerts a force on the flange 479. This force is translated through the structure of the side clamp 470 to the member 474 to exert a clamping force on the cells 424.

According to an exemplary embodiment, the second surface 472 of the side clamp 470 defines a recessed area or cavity 485 that is configured to receive or contain a CSC (not shown) for the battery module 422. According to an exemplary embodiment, the CSC may be mounted on a member or trace board (e.g., a printed circuit board). The trace board includes the necessary wiring to connect the CSC to the individual cells and to connect the CSC to the battery management system (BMS) of the battery system. The trace board includes various connectors to make these connections possible (e.g., temperature connectors, electrical connectors, voltage connectors, etc.).

According to an exemplary embodiment, the battery module 422 includes at least one cell supervisory controller (CSC) to monitor and regulate the electrochemical cells as needed. According to one exemplary embodiment, a CSC may be located at each side of the battery module 422.

Referring now to FIGS. 8-9, a battery module 522 is shown according to another exemplary embodiment. According to an exemplary embodiment, the battery module 522 includes features similar to those in FIGS. 6-7 (with similar features to those in FIGS. 6-7 labeled with corresponding reference numbers in the 500 series).

As shown in FIGS. 8-9, the battery module 522 includes a plurality of electrochemical cells 524. According to an exemplary embodiment, each of the electrochemical cells 524 includes a top 525, a bottom 526 that is opposite the top 525, a first side 527, and a second side 528 opposite the first side 527. The electrochemical cell 524 also includes sides or faces 529, 630 that interconnect the top 525, bottom 526, first side 527, and second side 528. According to an exemplary embodiment, the cells 524 include at least one terminal (e.g., such as the positive and negative terminals shown in FIG. 19).

As shown in FIG. 8, the electrochemical cells 524 are provided side-by-side one another such that a face 529 of a first electrochemical cell 524 is adjacent a face 530 of a second electrochemical cell 524 (e.g., the cells face one another). As such, each of the first sides 527 of the electrochemical cells 524 are provided on a first side of the battery module 522 while all of the second sides 528 of each of the electrochemical cells 524 are provided on a second side of the battery module 522 opposite that of the first side of the battery module 522. According to one exemplary embodiment, an electrically insulative member (not shown) may be provided in between adjacent cells (i.e., between the faces 529, 530).

According to one exemplary embodiment, a space or gap may be provided between adjacent cells 524. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

According to an exemplary embodiment, the battery module 522 includes a member or structure shown as an end cap 540 provided at a first end of the battery module 522. According to an exemplary embodiment, the end cap 540 includes a first face 541 and a second face 542 generally opposite the first face 541. As shown in FIG. 8, the first face 541 is provided adjacent a face 529 of one of the electrochemical cells 524. The end cap 540 also includes a first end 543 and a second end 544 generally opposite of the first end 543 and a top 545 and a bottom 546 generally opposite the top 545.

According to an exemplary embodiment, the first and second ends 543, 544 and the top and bottom 545, 546 are each connected with a plurality of generally horizontal members 531 (beams, ribs, supports, braces, etc.) and a plurality of generally vertical members 532 (beams, ribs, supports, braces, etc.). As shown in FIG. 8, the horizontal and vertical members 531, 532 are coupled with one another at intersection points 533. According to one exemplary embodiment, the first face 541 of the end cap 540 is a generally solid surface (i.e., flat continuous surface). However, according to another exemplary embodiment, the first face 541 may contain openings or windows between the horizontal and vertical members 531, 532.

According to an exemplary embodiment, the end cap 540 includes internal passages 539 that extend from the top 545 of the end cap 540 to the bottom 546 of the end cap 540. The passages 539 have a generally cylindrical shape and include openings 549 which are configured to allow a bolt or fastener therethrough to couple the end cap 540 to the battery system (e.g., such as to the bottom 521 of the battery system housing).

According to an exemplary embodiment, the horizontal and vertical members 531, 532 of the end cap 540 also form a pair of apertures or openings 548. As shown in FIG. 8, according to an exemplary embodiment, the openings 548 are generally provided near the ends 543, 544 and extend from near the top 545 of the end cap 540 to near the bottom 546 of the end cap 540. As shown in FIG. 8, the openings 548 have a generally rectangular shape; however, the openings may have a different size, shape, or configuration according to other exemplary embodiments.

According to an exemplary embodiment, the openings 548 of the end cap 540 are in fluid communication with the thermal management features 550 of the battery module 522. These openings 548 are configured to allow a thermal management fluid (e.g., air, liquid, etc.) to pass therethrough and enter the thermal management feature 550 to cool or heat the electrochemical cells 524.

According to an exemplary embodiment, the end cap 540 includes features or bosses 535 that are configured to receive a fastener or tie rod 536 therethrough. As shown in FIG. 8, each of the bosses 535 are located substantially in a corner of the end cap 540. According to an exemplary embodiment, nuts 537 are used to tighten the tie rods 536 within the battery module 522.

As shown in FIG. 8, according to an exemplary embodiment, a second end cap 540 is provided at a second end of the battery module 522 opposite that of the first end cap 540. According to the exemplary embodiment shown in FIG. 8, the tie rod 536 extends through the bosses 535 of each of the end caps 540 and is tightened using the nuts 537 to exert a clamping force on the plurality of electrochemical cells 524 in a generally horizontal direction.

According to an exemplary embodiment, the battery module 522 includes a pair of structures shown as side clamps 570. The side clamps 570 include a first surface 571 and a second surface 572 generally opposite of the first surface 571. According to an exemplary embodiment, the first surface 571 faces the thermal management feature 550 of the battery module 522 and helps to position and/or retain the thermal management feature 550 adjacent the cells 524 within the battery module 522.

According to an exemplary embodiment, each of the thermal management features 550 is configured to route a thermal management fluid (e.g., air, liquid, etc.) through a passage (e.g., channel, path, route, conduit, etc.) within the thermal management feature 550. The passage may include a heat sink (such as, e.g., heat sinks 52, 152, 252, 352 shown in FIGS. 4A-4B) to transfer heat between the cells 524 and the thermal management fluid. According to one exemplary embodiment, the thermal management feature 550 includes a box-like structure or housing that is configured to define the passage for the thermal management fluid to pass therethrough.

As shown in FIG. 9, according to an exemplary embodiment, each of the thermal management features 550 includes a heat sink 552 having a base 554 that is coupled to the side of the electrochemical cell 524. The heat sink 552 further includes a plurality of fins 556 that extend out from the base 554. Passages 555 are provided between adjacent fins 556. As shown in FIG. 9, according to an exemplary embodiment, the fins 556 are tapered (e.g., become smaller) from the base 554 to a tip 558 of the fins 556. However, according to other exemplary embodiments, the fins may not be tapered or may have another configuration. According to other exemplary embodiments, the thermal management features 550 may be configured similar to the thermal management features discussed above in regard to FIGS. 4B-4D.

According to an exemplary embodiment, the passages 555 are configured to receive a thermal management fluid therethrough to cool or heat the heat sink 552 (and thus the cells 524). According to an exemplary embodiment, the thermal management fluid is a gas such as air, or a liquid such as a coolant (e.g., water, water/glycol mixture, refrigerant, etc.). According to one exemplary embodiment, the tips 558 of the fins 556 are in contact with the first surface 571 of the side clamps 570. However, according to other exemplary embodiments, the tips 558 may not contact the side clamps 570.

According to one exemplary embodiment, an electrically insulative member shown as insulator 568 may be provided between the heat sink 552 and the electrochemical cells 524. However, according to another exemplary embodiment, the insulator is not included within the battery module (i.e., the heat sink 552 is provided directly adjacent to the electrochemical cells 524).

According to an exemplary embodiment, the insulator 568 provides electrical insulation between the cell 524 and the heat sink 552 but allows thermal transfer to readily occur between the cell 524 and the heat sink 552. As shown in FIG. 9, the insulator 568 extends along the bottom 526 of the cell 524 between the cell 524 and a bottom 521 of the battery system housing.

According to an exemplary embodiment, the insulator 568 comprises an electrically insulating, yet thermally conductive material (e.g., silicone, polyvinyl chloride (PVC), or other suitable material). According to an exemplary embodiment, the insulator 568 has a thickness in the range of approximately 0.05 to 0.25 millimeters. According to another exemplary embodiment, the insulator 568 has a thickness of 0.13 millimeters. However, the thickness of the insulator 568 may be greater or smaller according to other exemplary embodiments.

According to one exemplary embodiment, a top portion 573 of the first surface 571 of the side clamp 570 includes a feature or member 574 for clamping the electrochemical cells 524 in a generally vertical direction. The member 574 extends out and away from the first surface 571 and extends over at least a portion of the top of the cells 524.

According to the exemplary embodiment shown in FIGS. 8-9, the top portion 575 of the second surface 572 includes a pair of projections 576 that form a groove 577 to hold or retain the tie rod 536. The second surface 572 also includes a bottom portion 578 having a slot 583 configured to receive a tie rod 536. The bottom portion 578 also has a flange 579 extending out from the second surface 572. A portion of the flange 579 is configured to interact with a portion of a flange 538 of the end cap 540. When the end cap 540 is coupled to the battery system (by the bolts extending through the passages 539), the flange 538 of the end cap 540 pushes down on the flange 579 of the side clamp 570 to exert a clamping force on the electrochemical cells 524 in a vertical direction.

According to an exemplary embodiment, the end cap 540 includes an extension or projection 590 configured to extend out from the top 545 of the end cap 540 and over at least a portion of one of the electrochemical cells 524. The projection 590 is configured to help align the end cap 540 with the side clamps 570 so that tie rods or fasteners may be aligned through the bosses 535 and the grooves 577, 583 of the side clamp 570.

According to an exemplary embodiment, the flange 538 of the end cap 540 includes a feature 581 that interacts with a feature 582 of the flange 579 of the side clamp 570. As shown in FIGS. 8-9, the features 581, 582 have a dovetail configuration that is configured to aid in positioning and retaining the end caps 540 with respect to the side clamps 570.

According to an exemplary embodiment, the second surface 572 of the side clamp 570 defines a recessed area or cavity 585 that is configured to receive or contain a CSC (not shown) for the battery module 522. According to other various exemplary embodiments, the location of the CSC may be different.

According to an exemplary embodiment, the CSC may be mounted on a member or trace board (e.g., a printed circuit board). The trace board includes the necessary wiring to connect the CSC to the individual cells and to connect the CSC to the battery management system (BMS) of the battery system. The trace board includes various connectors to make these connections possible (e.g., temperature connectors, electrical connectors, voltage connectors, etc.).

According to an exemplary embodiment, the battery module 522 includes at least one cell supervisory controller (CSC) to monitor and regulate the electrochemical cells as needed. According to one exemplary embodiment, a CSC may be located at each side of the battery module 522.

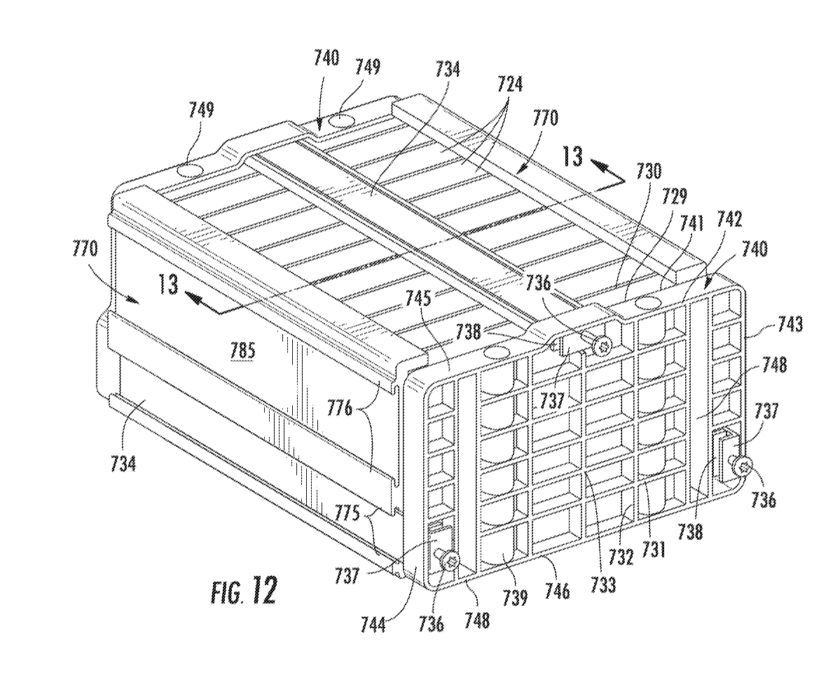

Referring now to FIGS. 10-11, a battery module 622 is shown according to another exemplary embodiment. According to an exemplary embodiment, the battery module 622 includes features similar to those in FIGS. 8-9 (with similar features to those in FIGS. 8-9 labeled with corresponding reference numbers in the 600 series).

As shown in FIGS. 10-11, the battery module 622 includes a plurality of electrochemical cells 624. According to an exemplary embodiment, each of the electrochemical cells 624 includes a top 625, a bottom 626 that is opposite the top 625, a first side 627, and a second side 628 opposite the first side 627. The electrochemical cell 624 also includes sides or faces 629, 630 that interconnect the top 625, bottom 626, first side 627, and second side 628. According to an exemplary embodiment, the cells 624 include at least one terminal (e.g., such as the positive and negative terminals shown in FIG. 19).

As shown in FIG. 10, the electrochemical cells 624 are provided side-by-side one another such that a face 629 of a first electrochemical cell 624 is adjacent a face 630 of a second electrochemical cell 624 (e.g., the cells face one another). As such, each of the first sides 627 of the electrochemical cells 624 are provided on a first side of the battery module 622 while all of the second sides 628 of each of the electrochemical cells 624 are provided on a second side of the battery module 622 opposite that of the first side of the battery module 622. According to one exemplary embodiment, an electrically insulative member (not shown) may be provided in between adjacent cells (i.e., between the faces 629, 630).

According to one exemplary embodiment, a space or gap may be provided between adjacent cells 624. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

According to an exemplary embodiment, the battery module 622 includes a member or structure shown as an end cap 640 provided at a first end of the battery module 622. According to an exemplary embodiment, the end cap 640 includes a first face 641 and a second face 642 generally opposite the first face 641. As shown in FIG. 10, the first face 641 is provided adjacent a face 629 of one of the electrochemical cells 624. The end cap 640 also includes a first end 643 and a second end 644 generally opposite of the first end 643 and a top 645 and a bottom 646 generally opposite the top 645.

According to an exemplary embodiment, the first and second ends 643, 644 and the top and bottom 645, 646 are each connected with a plurality of generally horizontal members 631 (beams, ribs, supports, braces, etc.), a plurality of generally vertical members 632 (beams, ribs, supports, braces, etc.), and a plurality of generally diagonal members 634 (beams, ribs, supports, braces, etc.). As shown in FIG. 10, the horizontal, vertical, and/or diagonal members 631, 632, 634 are coupled with one another at intersection points 633. According to one exemplary embodiment, the first face 641 of the end cap 640 is a generally solid surface (i.e., flat continuous surface). However, according to another exemplary embodiment, the first face 641 may contain openings or windows between the horizontal, vertical, and/or diagonal members 631, 632, 634.

According to an exemplary embodiment, the end cap 640 includes internal passages 639 that extend from the top 645 of the end cap 640 to the bottom 646 of the end cap 640. The passages 639 have a generally cylindrical shape and include openings 649 which are configured to allow a bolt or fastener therethrough to couple the end cap 640 to the battery system (e.g., such as to the bottom 621 of the battery system housing).

According to an exemplary embodiment, the end cap 640 forms a pair of apertures or openings 648. As shown in FIG. 10, according to an exemplary embodiment, the openings 648 are generally provided near the ends 643, 644 and extend from the top 645 of the end cap 640 to the bottom 646 of the end cap 640. As shown in FIG. 10, the openings 648 have a generally rectangular shape; however, the openings may have a different size, shape, or configuration according to other exemplary embodiments.

According to an exemplary embodiment, the openings 648 of the end cap 640 are in fluid communication with the thermal management features 650 of the battery module 622. These openings 648 are configured to allow a thermal management fluid (e.g., air, liquid, etc.) to pass therethrough and enter the thermal management feature 650 to cool or heat the electrochemical cells 624.

According to an exemplary embodiment, the end cap 640 includes features or bosses 635 that are configured to receive a fastener or tie rod 636 therethrough. As shown in FIG. 10, each of the features 635 are located substantially in a corner of the end cap 640. According to an exemplary embodiment, nuts 637 are used to tighten the tie rods 636 within the battery module 622.

As shown in FIG. 10, according to an exemplary embodiment, a second end cap 640 is provided at a second end of the battery module 622 opposite that of the first end cap 640. According to the exemplary embodiment shown in FIG. 10, the tie rod 636 extends through the features 635 of each of the end caps 640 and is tightened using the nuts 637 to exert a clamping force on the plurality of electrochemical cells 624 in a generally horizontal direction.

According to an exemplary embodiment, the battery module 622 includes a pair of members or structures shown as side clamps 670. The side clamps 670 include a first surface 671 and a second surface 672 generally opposite of the first surface 671. According to an exemplary embodiment, the first surface 671 faces the thermal management feature 650 of the battery module 622 and helps to position and/or retain the thermal management feature 650 adjacent the cells 624 within the battery module 622.

According to an exemplary embodiment, each of the thermal management features 650 is configured to route a thermal management fluid (e.g., air, liquid, etc.) through a passage (e.g., channel, path, route, conduit, etc.) within the thermal management feature 650. The passage may include a heat sink (such as, e.g., heat sinks 52, 152, 252, 352 shown in FIGS. 4A-4B) to transfer heat between the cells 624 and the thermal management fluid. According to one exemplary embodiment, the thermal management feature 650 includes a box-like structure or housing that is configured to define the passage for the thermal management fluid to pass therethrough.

As shown in FIG. 11, according to an exemplary embodiment, each of the thermal management features 650 includes a heat sink 652 having a base 654 that is coupled to the side of the electrochemical cell 624. The heat sink 652 further includes a plurality of fins 656 that extend out from the base 654. Passages 655 are provided between adjacent fins 656. As shown in FIG. 11, according to an exemplary embodiment, the fins 656 are tapered (e.g., become smaller) from the base 654 to a tip 658 of the fins 656. However, according to other exemplary embodiments, the fins may not be tapered or may have another configuration. According to other exemplary embodiments, the thermal management features 650 may be configured similar to the thermal management features discussed above in regard to FIGS. 4B-4D.

According to an exemplary embodiment, the passages 655 are configured to receive a thermal management fluid therethrough to cool or heat the heat sink 652 (and thus the cells 624). According to an exemplary embodiment, the thermal management fluid is a gas such as air, or a liquid such as a coolant (e.g., water, water/glycol mixture, refrigerant, etc.). According to one exemplary embodiment, the tips 658 of the fins 656 are in contact with the first surface 671 of the side clamps 670. However, according to other exemplary embodiments, the tips 658 may not contact the side clamps 670.

According to one exemplary embodiment, an electrically insulative member shown as insulator 668 may be provided between the heat sink 652 and the electrochemical cells 624. However, according to another exemplary embodiment, the insulator is not included within the battery module (i.e., the heat sink 652 is provided directly adjacent to the electrochemical cells 624).

According to an exemplary embodiment, the insulator 668 provides electrical insulation between the cell 624 and the heat sink 652 but allows thermal transfer to readily occur between the cell 624 and the heat sink 652. As shown in FIG. 11, the insulator 668 extends along the bottom 626 of the cell 624 between the cell 624 and a bottom 621 of the battery system housing.

According to an exemplary embodiment, the insulator 668 comprises an electrically insulating, yet thermally conductive material (e.g., silicone, polyvinyl chloride (PVC), or other suitable material). According to an exemplary embodiment, the insulator 668 has a thickness in the range of approximately 0.05 to 0.25 millimeters. According to another exemplary embodiment, the insulator 668 has a thickness of 0.13 millimeters. However, the thickness of the insulator 668 may be greater or smaller according to other exemplary embodiments.

According to one exemplary embodiment, a top portion 673 of the first surface 671 of the side clamp 670 includes a feature or member 674 for clamping the electrochemical cells 624 in a generally vertical direction. The member 674 extends out and away from the first surface 671 and extends over at least a portion of the top of the cells 624.

According to the exemplary embodiment shown in FIGS. 10-11, the top portion 675 of the second surface 672 includes a pair of projections 676 that form a groove 677 to hold or retain the tie rod 636. The second surface 672 also includes a bottom portion 678 having a slot 683 configured to receive a tie rod 636. The bottom portion 678 also has a flange 679 extending out from the second surface 672. A portion of the flange 679 is configured to interact with a portion of a flange 638 of the end cap 640. When the end cap 640 is coupled to the battery system (by the bolts extending through the passages 639), the flange 638 of the end cap 640 pushes down (i.e., exerts a force) on the flange 679 of the side clamp 670 to exert a clamping force on the electrochemical cells 624 in a generally vertical direction.

As shown in FIGS. 10-11, the flange 638 includes a pair of plates 690 that are spaced apart to form a groove or channel 691. The channel 691 is configured to receive and retain or hold a cell supervisory controller (CSC). According to an exemplary embodiment, the second surface 672 of the side clamp 670 defines a recessed area or cavity 685 that is configured to receive or contain the CSC (not shown) in conjunction with the channels 691. According to other various exemplary embodiments, the location of the CSC may be different.

According to an exemplary embodiment, the CSC may be mounted on a member or trace board (e.g., a printed circuit board). The trace board includes the necessary wiring to connect the CSC to the individual cells and to connect the CSC to the battery management system (BMS) of the battery system. The trace board includes various connectors to make these connections possible (e.g., temperature connectors, electrical connectors, voltage connectors, etc.).

According to an exemplary embodiment, each battery module 622 includes at least one cell supervisory controller (CSC) to monitor and regulate the electrochemical cells as needed. According to one exemplary embodiment, a CSC may be located at each side of the battery module 622.

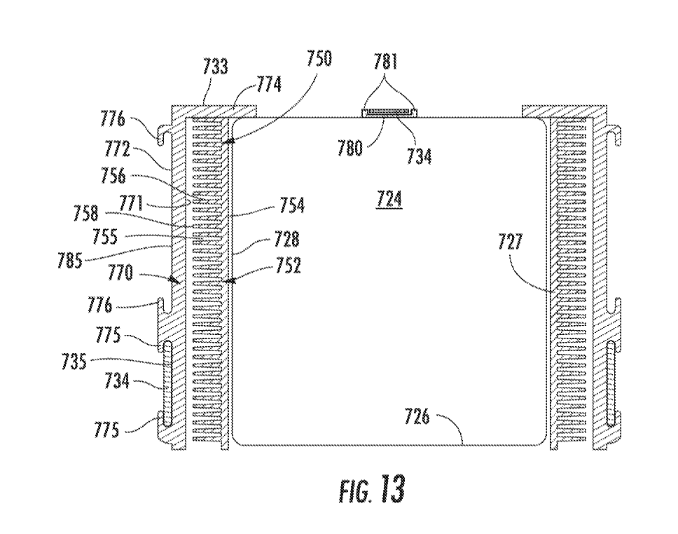

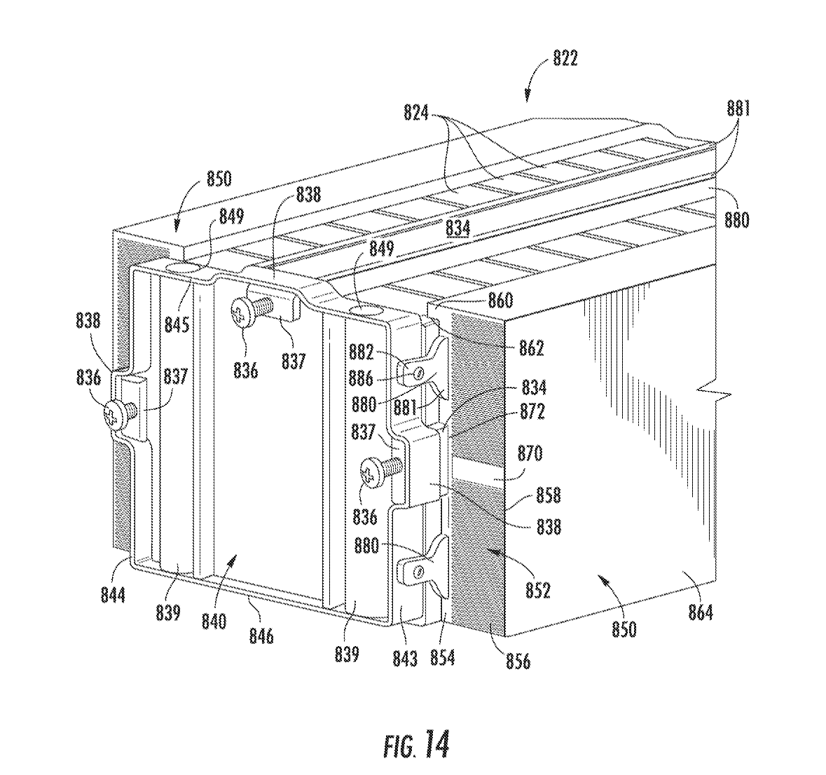

Referring now to FIGS. 12-13, a battery module 722 is shown according to another exemplary embodiment. The battery module 722 includes a plurality of electrochemical cells 724. According to an exemplary embodiment, each of the electrochemical cells 724 includes a top 725, a bottom 726 that is opposite the top 725, a first side 727, and a second side 728 opposite the first side 727. The electrochemical cell 724 also includes sides or faces 729, 730 that interconnect the top 725, bottom 726, first side 727, and second side 728. According to an exemplary embodiment, the cells 724 include at least one terminal (e.g., such as the positive and negative terminals shown in FIG. 19).

As shown in FIG. 12, the electrochemical cells 724 are provided side-by-side one another such that a face 729 of a first electrochemical cell 724 is adjacent a face 730 of a second electrochemical cell 724 (e.g., the cells face one another). As such, each of the first sides 727 of the electrochemical cells 724 are provided on a first side of the battery module 722 while all of the second sides 728 of each of the electrochemical cells 724 are provided on a second side of the battery module 722 opposite that of the first side of the battery module 722. According to one exemplary embodiment, an electrically insulative member (not shown) may be provided in between adjacent cells (i.e., between the faces 729, 730).

According to one exemplary embodiment, a space or gap may be provided between adjacent cells 724. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

According to an exemplary embodiment, the battery module 722 includes a member or structure shown as an end cap 740 provided at a first end of the battery module 722. According to an exemplary embodiment, the end cap 740 includes a first face 741 and a second face 742 generally opposite the first face 741. As shown in FIG. 12, the first face 741 is provided adjacent a face 729 of one of the electrochemical cells 724. The end cap 740 also includes a first end 743 and a second end 744 generally opposite of the first end 743 and a top 745 and a bottom 746 generally opposite the top 745.

According to an exemplary embodiment, the first and second ends 743, 744 and the top and bottom 745, 746 are each connected with a plurality of generally horizontal members 731 (beams, ribs, supports, braces, etc.) and a plurality of generally vertical members 732 (beams, ribs, supports, braces, etc.). As shown in FIG. 12, the horizontal and vertical members 731, 732 are coupled with one another at intersection points 733. According to one exemplary embodiment, the first face 741 of the end cap 740 is a generally solid surface (i.e., flat continuous surface). However, according to another exemplary embodiment, the first face 741 may contain openings or windows between the horizontal and vertical members 731, 732.

According to an exemplary embodiment, the end cap 740 includes internal passages 739 that extend from the top 745 of the end cap 740 to the bottom 746 of the end cap 740. The passages 739 have a generally cylindrical shape and include openings 749 which are configured to allow a bolt or fastener therethrough to couple the end cap 740 to the battery system (e.g., such as to the bottom of the battery system housing).

According to an exemplary embodiment, the end cap 740 forms a pair of apertures or openings 748. As shown in FIG. 12, according to an exemplary embodiment, the openings 748 are generally provided near the ends 743, 744 and extend from the top 745 of the end cap 740 to the bottom 746 of the end cap 740. As shown in FIG. 12, the openings 748 have a generally rectangular shape; however, the openings may have a different size, shape, or configuration according to other exemplary embodiments.

According to an exemplary embodiment, the openings 748 of the end cap 740 are in fluid communication with the thermal management features 750 of the battery module 722. These openings 748 are configured to allow a thermal management fluid (e.g., air, liquid, etc.) to pass therethrough and enter the thermal management feature 750 to cool or heat the electrochemical cells 724.

According to an exemplary embodiment, the end cap 740 is configured to receive ends 737 of members shown as bands 734. Each of the ends 737 receives a fastener or bolt 736 that is used to put a tension or force on the bands 734. According to the exemplary embodiment shown in FIG. 12, an end of each of the bolts 736 pushes against a member shown as a plate 738, which exerts a force on the end cap 740. This force on the end cap 740 acts to contain the cells 724 together within the battery module 722. As shown in FIG. 12, three bands 734 are used; however, a greater or lesser number of bands may be used according to other exemplary embodiments.

According to an exemplary embodiment, the bands 734 are manufactured from any suitable material (such as, e.g., a spring steel). As shown in FIG. 12, a top band 734 is provided in a member shown as a tray 780. According to an exemplary embodiment, the tray is manufactured from any suitable material (e.g., an electrically insulative material). As shown in FIG. 12, according to an exemplary embodiment, the tray 780 includes edges or sides 781 that aid in positioning and containing the band 734 within the tray 780.

As shown in FIG. 12, according to an exemplary embodiment, a second end cap 740 is provided at a second end of the battery module 722 opposite that of the first end cap 740. According to the exemplary embodiment shown in FIG. 12, the bands 734 extend from the first end of the battery module 722 to the second end of the battery module 722. According to one exemplary embodiment, a second set of fasteners or bolts 736 are provided on the second end of the battery module 722 to allow for adjustment of the tension of the bands 734 from both ends of the battery module 722. However, according to another exemplary embodiment, the ends 737 of the bands 734 may simply be held in place by the second end cap 740. In other words, the second ends 737 of the bands 734 are fixed in the second end cap 740. In both embodiments, the bands 734 are placed in tension (stretched or tightened) to exert a clamping force on the end caps 740 (and thus on the plurality of electrochemical cells 724) in a generally horizontal direction.

According to an exemplary embodiment, the battery module 722 includes a pair of members or structures shown as side clamps 770. The side clamps 770 include a first surface 771 and a second surface 772 generally opposite of the first surface 771. According to an exemplary embodiment, the first surface 771 faces the thermal management feature 750 of the battery module 722 and helps to position and/or retain the thermal management feature 750 adjacent the cells 724 within the battery module 722.

According to an exemplary embodiment, each of the thermal management features 750 is configured to route a thermal management fluid (e.g., air, liquid, etc.) through a passage (e.g., channel, path, route, conduit, etc.) within the thermal management feature 750. The passage may include a heat sink (such as, e.g., heat sinks 52, 152, 252, 352 shown in FIGS. 4A-4B) to transfer heat between the cells 724 and the thermal management fluid. According to one exemplary embodiment, the thermal management feature 750 includes a box-like structure or housing that is configured to define the passage for the thermal management fluid to pass therethrough.

As shown in FIG. 13, according to an exemplary embodiment, each of the thermal management features 750 includes a heat sink 752 having a base 754 that is coupled to the side of the electrochemical cell 724. The heat sink 752 further includes a plurality of fins 756 that extend out from the base 754. Passages 755 are provided between adjacent fins 756. As shown in FIG. 13, according to an exemplary embodiment, the fins 756 are tapered (e.g., become smaller) from the base 754 to a tip 758 of the fins 756. However, according to other exemplary embodiments, the fins may not be tapered or may have another configuration. According to other exemplary embodiments, the thermal management features 750 may be configured similar to the thermal management features discussed above in regard to FIGS. 4B-4D.

According to an exemplary embodiment, the passages 755 are configured to receive a thermal management fluid therethrough to cool or heat the heat sink 752 (and thus the cells 724). According to an exemplary embodiment, the thermal management fluid is a gas such as air, or a liquid such as a coolant (e.g., water, water/glycol mixture, refrigerant, etc.). According to one exemplary embodiment, the tips 758 of the fins 756 are in contact with the first surface 771 of the side clamps 770. However, according to other exemplary embodiments, the tips 758 may not contact the side clamps 770.

According to one exemplary embodiment, a top portion 773 of the first surface 771 of the side clamp 770 includes a feature or member 774 for clamping the electrochemical cells 724 in a generally vertical direction. The member 774 extends out and away from the first surface 771 and extends over at least a portion of the top of the cells 724.

According to the exemplary embodiment shown in FIGS. 12-13, the second surface 772 includes a pair of projections 775 that form a groove or slot 735 that is configured to hold or retain one of the bands 734. According to an exemplary embodiment, the projections 775 of the side clamp 770 are positioned such that when the band 734 is tightened, the side clamp 770 is also pulled down. This in turn exerts a generally vertical force on the cells 724 via the member 774. In other words, tightening the band 734 not only exerts a force in a generally horizontal direction (e.g., a first direction) via the end caps 740, but also exerts a force in a generally vertical direction (e.g., a second direction) via the side clamps 770.

As shown in FIGS. 12-13, each of the side clamps 770 includes a pair of projections 776 that are spaced apart from one another to form a groove or channel 785. The channel 785 is configured to receive and retain or hold a cell supervisory controller (CSC). According to other various exemplary embodiments, the location of the CSC may be different.

According to an exemplary embodiment, the CSC may be mounted on a member or trace board (e.g., a printed circuit board). The trace board includes the necessary wiring to connect the CSC to the individual cells and to connect the CSC to the battery management system (BMS) of the battery system. The trace board includes various connectors to make these connections possible (e.g., temperature connectors, electrical connectors, voltage connectors, etc.).

According to an exemplary embodiment, each battery module 722 includes at least one cell supervisory controller (CSC) to monitor and regulate the electrochemical cells as needed. According to one exemplary embodiment, a CSC may be located at each side of the battery module 722.

Referring now to FIG. 14, a battery module 822 is shown according to another exemplary embodiment. The battery module 822 includes a plurality of electrochemical cells 824. According to an exemplary embodiment, the cells 824 include at least one terminal (e.g., such as the positive and negative terminals shown in FIG. 19). According to an exemplary embodiment, as shown in FIG. 14, the electrochemical cells 824 are provided side-by-side one another (e.g., the cells face one another). According to one exemplary embodiment, an electrically insulative member (not shown) may be provided in between adjacent cells (i.e., between the faces of the cells).

According to one exemplary embodiment, a space or gap may be provided between adjacent cells 824. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

According to an exemplary embodiment, the battery module 822 includes a member or structure shown as an end cap 840 provided at a first end of the battery module 822. According to an exemplary embodiment, the end cap 840 includes a first face 841 and a second face 842 generally opposite the first face 841. As shown in FIG. 14, the first face 841 is provided adjacent a face of one of the electrochemical cells 824. The end cap 840 also includes a first end 843 and a second end 844 generally opposite of the first end 843 and a top 845 and a bottom 846 generally opposite the top 845.

According to an exemplary embodiment, the end cap 840 includes internal passages 839 that extend from the top 845 of the end cap 840 to the bottom 846 of the end cap 840. The passages 839 have a generally cylindrical shape and include openings 849 which are configured to allow a bolt or fastener therethrough to couple the end cap 840 to the battery system (e.g., such as to the bottom of the battery system housing).

According to an exemplary embodiment, the end cap 840 is configured to receive ends 837 of members shown as bands 834. Each of the ends 837 receives a fastener or bolt 836 that is used to put a tension or force on the bands 834. According to the exemplary embodiment shown in FIG. 14, an end of each of the bolts 836 pushes against the end cap 840, which exerts a compressive force on the end cap 840. This force on the end cap 840 acts to contain the cells 824 together within the battery module 822. As shown in FIG. 14, three bands 834 are used; however, a greater or lesser number of bands may be used according to other exemplary embodiments.

According to an exemplary embodiment, the bands 834 are manufactured from any suitable material (such as, e.g., a spring steel). As shown in FIG. 14, a top band 834 is provided in a member shown as a tray 880. According to an exemplary embodiment, the tray is manufactured from any suitable material (e.g., an electrically insulative material). As shown in FIG. 14, according to an exemplary embodiment, the tray 880 includes edges or sides 881 that aid in positioning and containing the band 834 within the tray 880.

According to the exemplary embodiment shown in FIG. 14, the end cap 840 includes a plurality of projections or flanges 838 that extend out from the top 845 and sides 843, 844 of the end cap 840. These flanges 838 include openings or apertures that receive the ends 837 of the bands 834. According to the exemplary embodiment shown in FIG. 14, the flanges 838 are located generally in the center of the top 845 and sides 843, 843 of the end cap 840. However, according to other exemplary embodiments, the flanges may be located elsewhere.

According to an exemplary embodiment, the second ends (not shown) of the bands 834 may be provided in either a fixed or adjustable configuration, similar to as described above in regard to the bands 734 of the battery module 722. As such, the bands 834 are placed in tension (stretched or tightened) to exert a clamping force on the end caps 840 and thus on the plurality of electrochemical cells 824 in a generally horizontal direction.

According to an exemplary embodiment, the battery module 822 includes a pair of thermal management features 850. According to an exemplary embodiment, each of the thermal management features 850 is configured to route a thermal management fluid (e.g., air, liquid, etc.) through a passage (e.g., channel, path, route, conduit, etc.) within the thermal management feature 850. The passage may include a heat sink (such as, e.g., heat sinks 52, 152, 252, 352 shown in FIGS. 4A-4B) to transfer heat between the cells 824 and the thermal management fluid. According to one exemplary embodiment, the thermal management feature 850 includes a box-like structure or housing that is configured to define the passage for the thermal management fluid to pass therethrough.

As shown in FIG. 14, according to an exemplary embodiment, each of the thermal management features 850 includes a heat sink 852 having a base 854 that is coupled to the sides of the electrochemical cells 824. The heat sink 852 further includes a plurality of fins 856 that extend out from the base 854. Passages 855 are provided between adjacent fins 856. As shown in FIG. 14, according to an exemplary embodiment, the fins 856 are generally straight from the base 854 to a tip 858 of the fins 856. However, according to other exemplary embodiments, the fins may be tapered (e.g., become smaller or larger from the base to the tip) or may have another configuration. According to other exemplary embodiments, the thermal management features 850 may be configured similar to the thermal management features discussed above in regard to FIGS. 4B-4D.

According to an exemplary embodiment, the passages 855 are configured to receive a thermal management fluid therethrough to cool or heat the heat sink 852 (and thus the cells 824). According to an exemplary embodiment, the thermal management fluid is a gas such as air, or a liquid such as a coolant (e.g., water, water/glycol mixture, refrigerant, etc.). As shown in FIG. 14, according to an exemplary embodiment, the thermal management feature 850 includes a cover 864 provided over the fins 856 of the heat sink 852. According to one exemplary embodiment, the tips 858 of the fins 856 are in contact with the cover 864. However, according to other exemplary embodiments, the tips 858 may not contact the cover 864.

According to one exemplary embodiment, the heat sink 852 of the thermal management feature 850 includes a feature or member 860 for clamping the electrochemical cells 824 in a generally vertical direction. The member 860 extends out and away from the base 854 of the heat sink 852 in a direction generally opposite that of the fins 856 to extend over at least a portion of the top of the cells 824. The member 860 includes a face 862 that is configured to exert a force on a portion of the top of the cells 824 in a generally vertical direction.

As shown in FIG. 14, the side bands 834 extend through a cutout 872 provided on the back side of the base 854 of the heat sink 852. According to one exemplary embodiment, the cutout 872 is configured such that when the band 834 is tightened, the heat sink 852 is also pulled down in a generally vertical direction. This in turn exerts a generally vertical force on the cells 824 via the member 860. In other words, tightening the band 834 not only exerts a force in a generally horizontal direction (e.g., a first direction) via the end caps 840, but also exerts a force in a generally vertical direction (e.g., a second direction) via the heat sink 852.

According to the exemplary embodiment shown in FIG. 14, the thermal management feature 850 is coupled to the end cap with a plurality of members shown as connection tabs 880. Each of the connection tabs 880 includes a first end 881 connected to the base 854 of the heat sink 852. Each of the connection tabs 880 also includes a second end 882 that defines a hole configured to receive a fastener 886 therethrough. The fastener is used to couple the connection tab 880 to the side of the end cap 840. As shown in FIG. 14, according to an exemplary embodiment, the first end 881 of the connection tab 880 is larger than the second end 882 of the connection tab 880. However according to other exemplary embodiments, the connection tab 880 may have a different configuration.

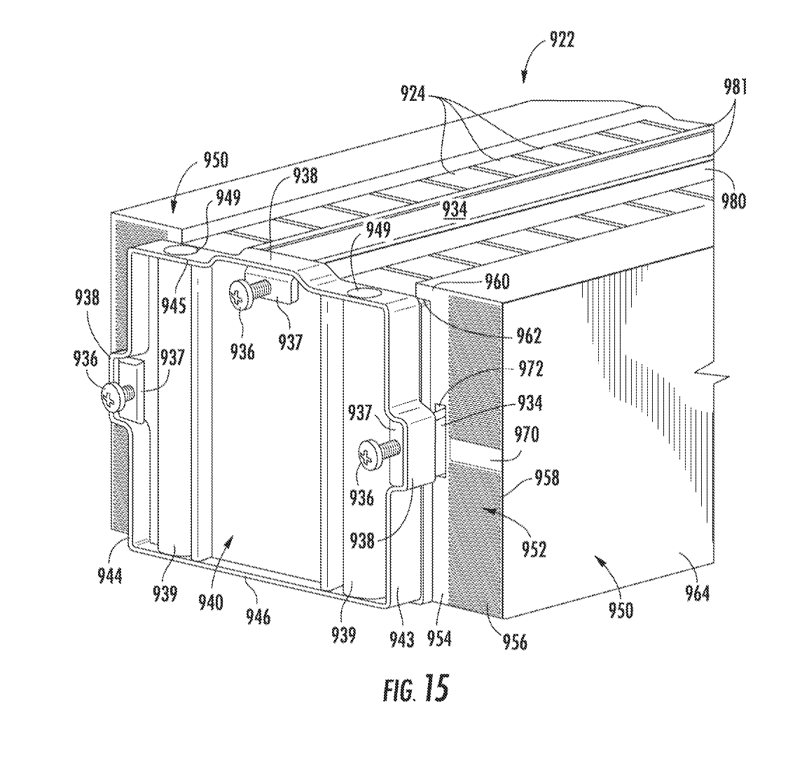

Referring now to FIG. 15, a battery module 922 is shown according to another exemplary embodiment. According to an exemplary embodiment, the battery module 922 includes features similar to those in FIG. 14 (with similar features to those in FIG. 14 labeled with corresponding reference numbers in the 900 series).

According to an exemplary embodiment, the battery module 922 includes a plurality of electrochemical cells 924. According to an exemplary embodiment, the cells 924 include at least one terminal (e.g., such as the positive and negative terminals shown in FIG. 19). As shown in FIG. 15, the electrochemical cells 924 are provided side-by-side one another (e.g., the cells face one another). According to one exemplary embodiment, an electrically insulative member (not shown) may be provided in between adjacent cells (i.e., between the faces of the cells).

According to one exemplary embodiment, a space or gap may be provided between adjacent cells 924. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

As shown in FIG. 15, the battery module 922 includes a member or structure shown as an end cap 940 provided at a first end of the battery module 922. According to an exemplary embodiment, the end cap 940 includes a first face 941 and a second face 942 generally opposite the first face 941. As shown in FIG. 15, the first face 941 is provided adjacent a face of one of the electrochemical cells 924. The end cap 940 also includes a first end 943 and a second end 944 generally opposite of the first end 943 and a top 945 and a bottom 946 generally opposite the top 945.

According to an exemplary embodiment, the end cap 940 includes internal passages 939 that extend from the top 945 of the end cap 940 to the bottom 946 of the end cap 940. The passages 939 have a generally cylindrical shape and include openings 949 which are configured to allow a bolt or fastener therethrough to couple the end cap 940 to the battery system (e.g., such as to the bottom of the battery system housing).

According to an exemplary embodiment, the end cap 940 is configured to receive ends 937 of members shown as bands 934. Each of the ends 937 receives a fastener or bolt 936 that is used to put a tension or force on the bands 934. According to the exemplary embodiment shown in FIG. 14, an end of each of the bolts 936 pushes against the end cap 940, which exerts a compressive force on the end cap 940. This force on the end cap 940 acts to contain the cells 924 together within the battery module 922. As shown in FIG. 15, three bands 934 are used; however, a greater or lesser number of bands may be used according to other exemplary embodiments.

According to the exemplary embodiment shown in FIG. 15, the end cap 940 includes a plurality of projections or flanges 938 that extend out from the top 945 and sides 943, 944 of the end cap 940. These flanges 938 include openings or apertures that receive the ends 937 of the bands 934. According to the exemplary embodiment shown in FIG. 14, the flanges 938 are located generally in the center of the top 945 and sides 943, 944 of the end cap 940. However, according to other exemplary embodiments, the flanges may be located elsewhere.

According to an exemplary embodiment, the bands 934 are manufactured from any suitable material (such as, e.g., a spring steel). As shown in FIG. 15, a top band 934 is provided in a member shown as a tray 980. According to an exemplary embodiment, the tray is manufactured from any suitable material (e.g., an electrically insulative material). As shown in FIG. 15, according to an exemplary embodiment, the tray 980 includes edges or sides 981 that aid in positioning and containing the band 934 within the tray 980.

According to an exemplary embodiment, the second ends (not shown) of the bands 934 may be provided in either a fixed or adjustable configuration, similar to as described above in regard to the bands 734 of the battery module 722. As such, the bands 934 are placed in tension (stretched or tightened) to exert a clamping force on the end caps 940 and thus on the plurality of electrochemical cells 924 in a generally horizontal direction.

According to an exemplary embodiment, the battery module 922 includes a pair of thermal management features 950. According to an exemplary embodiment, each of the thermal management features 950 is configured to route a thermal management fluid (e.g., air, liquid, etc.) through a passage (e.g., channel, path, route, conduit, etc.) within the thermal management feature 950. The passage may include a heat sink (such as, e.g., heat sinks 52, 152, 252, 352 shown in FIGS. 4A-4B) to transfer heat between the cells 924 and the thermal management fluid. According to one exemplary embodiment, the thermal management feature 950 includes a box-like structure or housing that is configured to define the passage for the thermal management fluid to pass therethrough.

As shown in FIG. 15, according to an exemplary embodiment, each of the thermal management features 950 includes a heat sink 952 having a base 954 that is coupled to the sides of the electrochemical cells 924. The heat sink 952 further includes a plurality of fins 956 that extend out from the base 954. Passages 955 are provided between adjacent fins 956. As shown in FIG. 15, according to an exemplary embodiment, the fins 956 are generally straight from the base 954 to a tip 958 of the fins 956. However, according to other exemplary embodiments, the fins may be tapered (e.g., become smaller or larger from the base to the tip) or may have another configuration. According to other exemplary embodiments, the thermal management features 950 may be configured similar to the thermal management features discussed above in regard to FIGS. 4A-4D.

According to an exemplary embodiment, the passages 955 are configured to receive a thermal management fluid therethrough to cool or heat the heat sink 952 (and thus the cells 924). According to an exemplary embodiment, the thermal management fluid is a gas such as air, or a liquid such as a coolant (e.g., water, water/glycol mixture, refrigerant, etc.). As shown in FIG. 15, according to an exemplary embodiment, the thermal management feature 950 includes a cover 964 provided over the fins 956 of the heat sink 952. According to one exemplary embodiment, the tips 958 of the fins 956 are in contact with the cover 964. However, according to other exemplary embodiments, the tips 958 may not contact the cover 964.

According to one exemplary embodiment, the heat sink 952 of the thermal management feature 950 includes a feature or member 960 for clamping the electrochemical cells 924 in a generally vertical direction. The member 960 extends out and away from the base 954 of the heat sink 952 in a direction generally opposite that of the fins 956 to extend over at least a portion of the top of the cells 924. The member 960 includes a face 962 that is configured to exert a force on a portion of the top of the cells 924 in a generally vertical direction.

As shown in FIG. 15, the side bands 934 extend through a slot or opening 972 provided within the base 954 of the heat sink 952. According to one exemplary embodiment, the opening 972 is configured such that when the band 934 is tightened, the heat sink 952 is also pulled down in a generally vertical direction. For example, an edge of the band 934 exerts a force on a lower edge of the opening 972. This in turn exerts a clamping force on the cells 924 in a generally vertical direction via the member 960. In other words, tightening the band 934 not only exerts a force in a generally horizontal direction (e.g., a first direction) via the end caps 940, but also exerts a force in a generally vertical direction (e.g., a second direction) via the opening 972 of the heat sink 952.

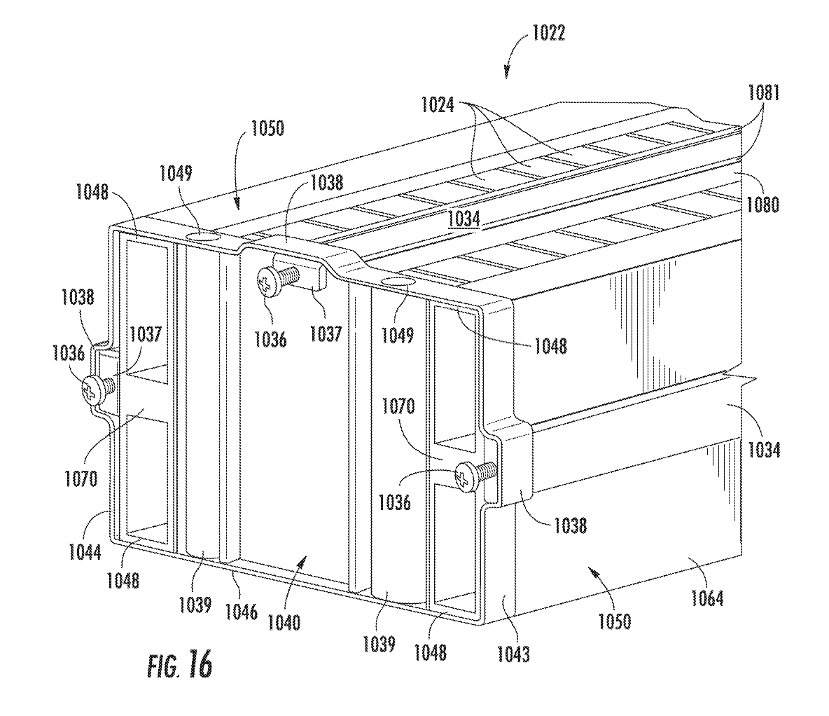

Referring now to FIG. 16, a battery module 1022 is shown according to another exemplary embodiment. According to an exemplary embodiment, the battery module 1022 includes features similar to those in FIG. 14 (with similar features to those in FIG. 14 labeled with corresponding reference numbers in the 1000 series).

According to an exemplary embodiment, the battery module 1022 includes a plurality of electrochemical cells 1024. According to an exemplary embodiment, the cells in FIG. 19). As shown in FIG. 16, the electrochemical cells 1024 are provided side-by-side one another (e.g., the cells face one another). According to one exemplary embodiment, an electrically insulative member (not shown) may be provided in between adjacent cells (i.e., between the faces of the cells).

According to one exemplary embodiment, a space or gap may be provided between adjacent cells 1024. For example, one or more spacers or other members (not shown) may be provided on or in between the faces of adjacent cells to allow air or liquid (e.g., thermal management fluid) to pass between the faces of the adjacent cells. According to this exemplary embodiment, the cells would still be able to be clamped together (i.e., the spacers or other members would allow for rigid connections between the cells).

As shown in FIG. 16, the battery module 1022 includes a member or structure shown as an end cap 1040 provided at a first end of the battery module 1022. According to an exemplary embodiment, the end cap 1040 includes a first face 1041 and a second face 1042 generally opposite the first face 1041. As shown in FIG. 16, the first face 1041 is provided adjacent a face of one of the electrochemical cells 1024. The end cap 1040 also includes a first end 1043 and a second end 1044 generally opposite of the first end 1043 and a top 1045 and a bottom 1046 generally opposite the top 1045.

According to an exemplary embodiment, the end cap 1040 includes internal passages 1039 that extend from the top 1045 of the end cap 1040 to the bottom 1046 of the end cap 1040. The passages 1039 have a generally cylindrical shape and include openings 1049 which are configured to allow a bolt or fastener therethrough to couple the end cap 1040 to the battery system (e.g., such as to the bottom of the battery system housing).

According to an exemplary embodiment, the end cap 1040 is configured to receive ends 1037 of members shown as bands 1034. Each of the ends 1037 receives a fastener or bolt 1036 that is used to put a tension or force on the bands 1034. According to the exemplary embodiment shown in FIG. 16, an end of each of the bolts 1036 pushes against the end cap 1040, which exerts a compressive force on the end cap 1040. This force on the end cap 1040 acts to contain the cells 1024 together within the battery module 1022. As shown in FIG. 16, three bands 1034 are used; however, a greater or lesser number of bands may be used according to other exemplary embodiments.

According to the exemplary embodiment shown in FIG. 16, the end cap 1040 includes a plurality of projections or flanges 1038 that extend out from the top 1045 and sides 1043, 1044 of the end cap 1040. These flanges 1038 include openings or apertures that receive the ends 1037 of the bands 1034. According to the exemplary embodiment shown in FIG. 16, the flanges 1038 are located generally in the center of the top 1045 and sides 1043, 1044 of the end cap 1040. However, according to other exemplary embodiments, the flanges may be located elsewhere.

According to an exemplary embodiment, the bands 1034 are manufactured from any suitable material (such as, e.g., a spring steel). As shown in FIG. 16, a top band 1034 is provided in a member shown as a tray 1080. According to an exemplary embodiment, the tray is manufactured from any suitable material (e.g., an electrically insulative material). As shown in FIG. 16, according to an exemplary embodiment, the tray 1080 includes edges or sides 1081 that aid in positioning and containing the band 1034 within the tray 1080.

According to an exemplary embodiment, the second ends (not shown) of the bands 1034 may be provided in either a fixed or adjustable configuration, similar to as described above in regard to the bands 734 of the battery module 722. As such, the bands 1034 are placed in tension (stretched or tightened) to exert a clamping force on the end caps 1040 and thus on the plurality of electrochemical cells 1024 in a generally horizontal direction.

According to an exemplary embodiment, the end cap 1040 forms a plurality of apertures or openings 1048. As shown in FIG. 16, according to an exemplary embodiment, the openings 1048 are generally provided near the ends 1043, 1044. A first pair of openings 1048 extend generally from the top 1045 of the end cap 1040 to the bottom 1046 of the end cap 1040 and are separated by a member shown as a divider 1070.

As shown in FIG. 16, the openings 1048 have a generally rectangular shape; however, the openings may have a different size, shape, or configuration according to other exemplary embodiments. According to an exemplary embodiment, the openings 1048 of the end cap 1040 are in fluid communication with the thermal management features 1050 of the battery module 1022. These openings 1048 are configured to allow a thermal management fluid (e.g., air, liquid, etc.) to pass therethrough and enter the thermal management features 1050 to cool or heat the electrochemical cells 1024.

According to an exemplary embodiment, the battery module 1022 includes a pair of thermal management features 1050. According to an exemplary embodiment, each of the thermal management features 1050 is configured to route a thermal management fluid (e.g., air, liquid, etc.) through a passage (e.g., channel, path, route, conduit, etc.) within the thermal management feature 1050. The passage may include a heat sink (such as, e.g., heat sinks 52, 152, 252, 352 shown in FIGS. 4A-4B) to transfer heat between the cells 1024 and the thermal management fluid. According to one exemplary embodiment, the thermal management feature 1050 includes a box-like structure or housing that is configured to define the passage for the thermal management fluid to pass therethrough.

As shown in FIG. 16, according to an exemplary embodiment, each of the thermal management features 1050 includes a heat sink 1052 having a base 1054 that is coupled to the sides of the electrochemical cells 1024. The heat sink 1052 further includes a plurality of fins 1056 that extend out from the base 1054. Passages 1055 are provided between adjacent fins 1056. As shown in FIG. 16, according to an exemplary embodiment, the fins 1056 are generally straight from the base 1054 to a tip 1058 of the fins 1056. However, according to other exemplary embodiments, the fins may be tapered (e.g., become smaller or larger from the base to the tip) or may have another configuration. According to other exemplary embodiments, the thermal management features 1050 may be configured similar to the thermal management features discussed above in regard to FIGS. 4A-4D.

According to an exemplary embodiment, the passages 1055 are configured to receive a thermal management fluid therethrough to cool or heat the heat sink 1052 (and thus the cells 1024). According to an exemplary embodiment, the thermal management fluid is a gas such as air, or a liquid such as a coolant (e.g., water, water/glycol mixture, refrigerant, etc.). As shown in FIG. 16, according to an exemplary embodiment, the thermal management 1050 feature includes a cover 1064 provided over the fins 1056 of the heat sink 1052. According to one exemplary embodiment, the tips 1058 of the fins 1056 are in contact with the cover 1064. However, according to other exemplary embodiments, the tips 1058 may not contact the cover 1064.

According to an exemplary embodiment, the heat sink 1052 may include a member or divider (not shown) that is in line with the divider 1070 of the end cap 1040. The divider of the heat sink 1052 may act in a similar fashion to the divider described above in regard to divider 170 and shown in FIG. 4B.

According to one exemplary embodiment, the heat sink 1052 of the thermal management feature 1050 includes a feature or member 1060 for clamping the electrochemical cells 1024 in a generally vertical direction. The member 1060 extends out and away from the base 1054 of the heat sink 1052 in a direction generally opposite that of the fins 1056 to extend over at least a portion of the top of the cells 1024. The member 1060 includes a face 1062 that is configured to exert a force on a portion of the top of the cells 1024 in a generally vertical direction.

As shown in FIG. 16, the side bands 1034 extend around the cover 1064 of the thermal management feature 1050. Tightening the band s1034 is configured to exert a force on the cells 1024 in a generally horizontal direction (e.g., a first direction) via the end caps 1040. Additionally, tightening the bands 1034 may also exert a force on the cells 1024 in a generally vertical direction (e.g., a second direction) via a member (not shown) provided in the cover 1064 of the thermal management feature 1050.

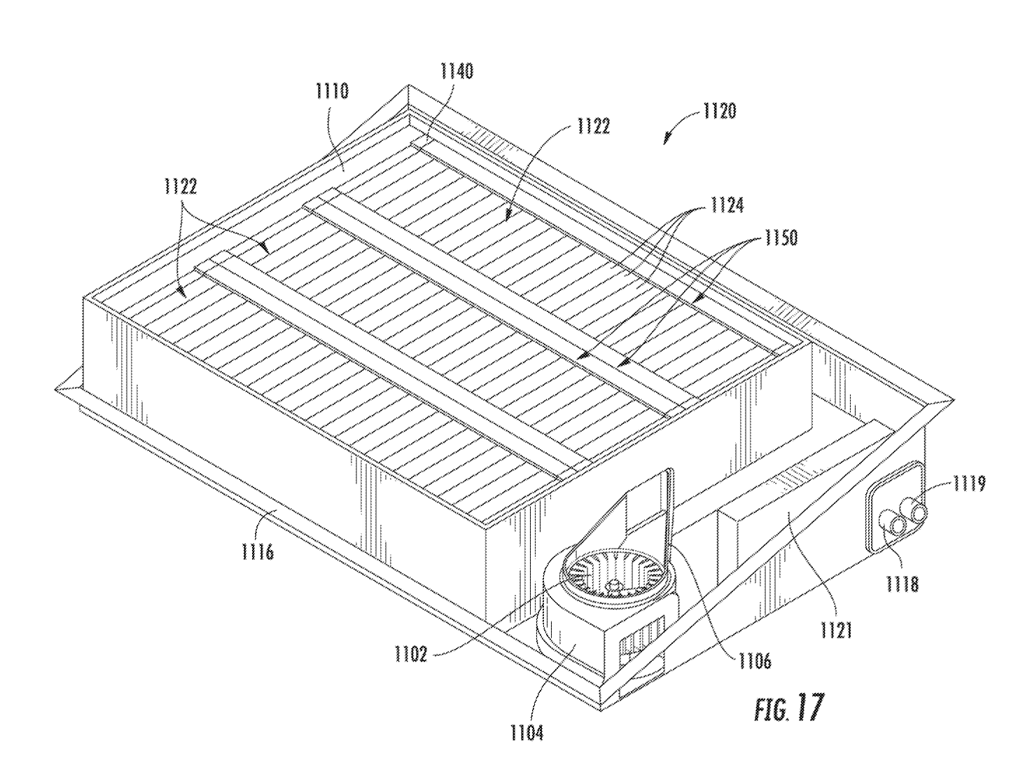

Referring now to FIGS. 17-18, a battery system 1120 is shown according to an exemplary embodiment. According to an exemplary embodiment, the battery system 1120 includes three battery modules 1122 (e.g., any of the battery modules discussed above and shown in FIGS. 3-16) located side-by-side inside a frame or housing 1116 (shown without the cover for clarity). According to other exemplary embodiments, a larger or smaller number of battery modules may be included in the battery system, depending on the desired power of the battery system. According to other exemplary embodiments, the battery modules may be located in a configuration other than side-by-side (e.g., end-to-end, etc.). According to an exemplary embodiment, the housing 1116 may include a member or cover (not shown) that encloses the components of the battery system.

According to an exemplary embodiment, each of the battery modules 1122 includes a plurality of electrochemical cells 1124 provided between end caps 1140 (similar those shown in FIG. 3). According to an exemplary embodiment, the cells 1124 include at least one terminal (e.g., such as the positive and negative terminals shown in FIG. 19). Each of the cells 1124 are electrically coupled to one or more other cells or other components of the battery system 1120 (e.g., by welding, such as ultrasonic or laser welding, or by connectors or similar elements—not shown).

Still referring to FIGS. 17-18, the battery system 1120 includes a device shown as a fan 1102 for moving or handling a thermal management fluid through the thermal management features 1150 of the battery modules 1122. The fan 1102 is used to provide (e.g., force) a fluid (e.g., air, coolant, etc.) through each of the battery modules 1122. According to one exemplary embodiment, the fluid is drawn (pulled) through the battery modules 1122. According to another exemplary embodiment, the fluid is blown (pushed) through the battery modules 1122.

According to an exemplary embodiment, the battery system includes manifolds 1110, 1112 configured to route the thermal management fluid from a single source (e.g., the fan) to the individual thermal management features 1150 or vice versa. As shown in FIGS. 17-18, the flow of the thermal management fluid is generally from a first end of the battery system 1120 to a second end of the battery system 1120. However, according to other exemplary embodiments, the flow of the thermal management fluid may be otherwise configured (such as, e.g., the thermal management fluid may be configured to flow similar to that shown in FIGS. 5B-5C).

According to one exemplary embodiment, the fluid is used to cool the electrochemical cells 1124 in the battery modules 1122. According to another exemplary embodiment, the fluid is used to heat the electrochemical cells 1124 in the battery modules 1122. According to an exemplary embodiment, the fluid is sealed (e.g., contained) from the rest of the components of the battery system 1120 (e.g., via a fan housing 1104 and/or ductwork 1106).

According to an exemplary embodiment, the battery system 1120 includes a battery management system (BMS) 1121. According to an exemplary embodiment, the BMS 1121 is configured for regulating the electrochemical cells 1124 and other features of the battery system 1120. For example, the BMS 1121 may include features that are responsible for monitoring and controlling the electrical performance of the battery system 1120 and/or managing and controlling the regulation of thermal behavior of the battery system 1120. For example, the BMS 1121 may be configured to control the fan (or pump) that routes the thermal management fluid into the thermal management features of the battery modules to control the delivery rate of the fluid (and thus the rate of cooling or heating the cells).

As shown in FIGS. 17-18, the battery system 1120 includes a pair of connections 1118, 1119 that are configured to electrically connect the battery system 1120 to a vehicle or other device requiring electrical power.

Referring now to FIGS. 19-21, an electrochemical cell (e.g., a lithium-ion cell) is shown according to an exemplary embodiment. According to various exemplary embodiments, the electrochemical cell shown in FIGS. 19-21 may be used in any of the modules described above and shown in FIGS. 3-18.

The electrochemical cell includes a plurality of alternating stacked positive and negative electrode plates (not shown) that are separated from one another by an electrically insulative material (e.g., a separator). The separators (not shown) are provided intermediate or between the positive and negative electrodes to electrically isolate the electrodes from each other. According to an exemplary embodiment, the cell includes an electrolyte (not shown). According to an exemplary embodiment, the electrolyte is provided in the cell through a fill hole (not shown). According to an exemplary embodiment, the fill hole is plugged by a member such as a fill hole plug (e.g., as shown in FIG. 19).

According to an exemplary embodiment, the cell includes a positive current collector (not shown) that is configured to be conductively coupled to the positive electrodes of the cell. According to an exemplary embodiment, the positive current collector is configured to be conductively coupled to the housing of the cell. According to an exemplary embodiment, the housing is conductively coupled to a lid or cover of the cell. According to an exemplary embodiment, the cover comprises a positive terminal. According to an exemplary embodiment, the positive terminal is formed as a single integral component with the cover, but according to other exemplary embodiments, the positive terminal and the cover may be separate components.

According to an exemplary embodiment, the cell includes a negative current collector that is configured to be conductively coupled to the negative electrodes of the cell. According to an exemplary embodiment, the negative current collector is conductively coupled to a negative terminal of the cell. According to an exemplary embodiment, the negative current collector is conductively coupled to the negative terminal via members or contacts that are conductively coupled to the negative terminal and the negative current collector. According to an exemplary embodiment, multiple contacts are used to conductively couple the negative current collector to the negative terminal. According to an exemplary embodiment, the negative terminal comprises two areas of reduced size (e.g., reduced width, reduced thickness, etc.) shown as bus bars. According to an exemplary embodiment, the negative terminal is formed as a single integral component with the bus bars, but according to other exemplary embodiments, the negative terminal and the bus bars may be separate components.

According to an exemplary embodiment, the lid or cover of the cell includes holes or apertures that are covered by members shown as vents. According to an exemplary embodiment, the vents may bulge (e.g., dome, pop, etc.) when the pressure inside the cell increases to a predetermined pressure. When the vents bulge, they come into contact with the bus bars of the negative terminal. According to an exemplary embodiment, the vents, in the bulged state, cause the bus bars to fracture. According to an exemplary embodiment, the bus bars comprise a fracture zone (e.g., an area of reduced strength, such as a groove or notch). When each of the bus bars fracture, current is no longer allowed to flow from the negative electrodes to the negative terminal (i.e., the circuit is broken). According to an exemplary embodiment, in order for the current to be disrupted, both of the bus bars must fracture. According to other exemplary embodiments, only one bus bar may be used (thus, current may be disrupted by only one bus bar being fractured).

According to an exemplary embodiment, the vents may themselves fracture or separate from the cover of the cell, allowing high pressure gas and/or effluent from inside the cell to be released. According to an exemplary embodiment, the vents are configured to separate from the cover of the cell at a predetermined pressure. According to one exemplary embodiment, the vents are configured to separate from the cover of the cell at a predetermined pressure that is higher than the pressure that causes the bus bars to fracture. One advantage of this configuration is that the cell is configured to have the current interrupted prior to the gases and/or effluent released from the cell. This allows the cell to return to a reduced internal pressure once the current has been interrupted. Another advantage of this configuration is that the current has already been interrupted prior to the separation of the vent from the cell, thus significantly reducing the risk of an arc occurring.

According to an exemplary embodiment, the various components of the battery modules and systems described above may be constructed from any suitable materials. For example, the end caps and/or side clamps may be constructed from an electrically insulative material (e.g., a polymer, or a glass-filled polymer, etc.) or an electrically conductive material (e.g., aluminum, steel, etc.). Additionally, the electrically conductive material may be coated with a non-conductive material, or a non-conductive insulator may be provided between the electrically conductive material and other components. According to another exemplary embodiment, the heat sinks (and/or fins) may be constructed from any suitable material (e.g., aluminum or aluminum alloy, cooper or copper alloy, steel or steel alloy, etc.).

It should be noted that all of the possible variations and alternatives described herein and shown in the FIGS. 3-21 may apply to any and all of the separate embodiments included in this application.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the prismatic cell system with thermal management features as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. A battery module comprising:
a plurality of electrochemical cells provided side-by-side one another; and a thermal management feature extending substantially the length of the
battery module and coupled to a first side of each of the electrochemical cells, the thermal management feature comprising a passage though which a thermal management fluid may pass and a heat sink provided within the passage to transfer heat between the electrochemical cells and the thermal management fluid.

2. The battery module of claim 1, wherein an additional thermal management feature is coupled to a second side of each of the electrochemical cells that is opposite to the first side.

3. The battery module of claim 1, wherein the thermal management feature comprises a feature configured to exert a clamping force on the electrochemical cells in a first direction.

4. The battery module of claim 1, further comprising a structure configured to retain the thermal management feature in position with the electrochemical cells.

5. The battery module of claim 4, wherein the structure comprises a member configured to exert a clamping force on the electrochemical cells in a first direction.

6. The battery module of claim 5, further comprising a member configured to exert a clamping force on the electrochemical cells in a second direction.

7. The battery module of claim 6, wherein the member configured to exert a clamping force on the electrochemical cells in the second direction comprises a feature configured to exert a force on the member configured to exert a clamping force on the electrochemical cells in the first direction.

8. The battery module of claim 6, wherein one of the structure and the member configured to exert a clamping force on the electrochemical cells in a second direction is configured to retain a cell supervisory controller.

9. The battery module of claim 6, further comprising at least one band coupled to and extending out from the member configured to exert a clamping force on the electrochemical cells in a second direction.

10. The battery module of claim 1, further comprising an end cap comprising an opening in fluid communication with the passage of the thermal management feature.

11. The battery module of claim 1, wherein the thermal management feature is configured to route the thermal management fluid through the thermal management feature only in a single direction.

12. The battery module of claim 1, wherein the thermal management feature is configure to route the thermal management fluid through the thermal management feature in a first direction and in a second direction generally opposite the first direction.

13. The battery module of claim 1, wherein the battery module comprises a feature configured to change the direction of the flow of the thermal management fluid through the thermal management feature from the first direction to the second direction.

14. The battery module of claim 1, wherein the heat sink has a plurality of fins extending away from the plurality of electrochemical cells, wherein the thermal management fluid is configured to pass between the fins.

15. The battery module of claim 1, wherein the heat sink comprises a folded sheet having a first side coupled to a base of the heat sink.
